(19) United States
(12) Patent Application Publication
(10) Pub. No.: US 2019/0237748 A1
(43) Pub. Date: Aug. 1, 2019

(54) COMPOSITIONS AND METHODS FOR ENERGY STORAGE DEVICES HAVING IMPROVED PERFORMANCE

(71) Applicant: Maxwell Technologies, Inc., San Diego, CA (US)

(72) Inventors: Joon Ho Shin, San Diego, CA (US); Hieu Minh Duong, Rosemead, CA (US); Haim Feigenbaum, Irvine, CA (US)

(21) Appl. No.: 16/184,892

(22) Filed: Nov. 8, 2018

Related U.S. Application Data
(60) Provisional application No. 62/590,110, filed on Nov. 22, 2017.

(51) Int. Cl. H01M 4/131; H01M 4/133; H01M 4/62; H01M 4/04; H01M 10/0525

(52) U.S. Cl. CPC H01M 4/131; H01M 4/133; H01M 2004/021; H01M 4/0404; H01M 10/0525; H01M 4/623

(57) ABSTRACT

Provided herein are energy storage devices comprising at least one dry process, self-supporting electrode film having improved performance. The improved performance may be realized as improved electrode material loading, improved active material loading, improved active material density, improved areal capacity, improved specific capacity, improved areal energy density, improved energy density, improved specific energy density, or improved Coulombic efficiency.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority under 35 U.S.C. § 119(e) of U.S. Provisional Application No. 62/590,110, filed Nov. 22, 2017.

### BACKGROUND

### Field

The present invention relates generally to energy storage devices, and specifically to materials and methods for dry electrode energy storage devices having improved performance.

### Description of the Related Art

Electrical energy storage cells are widely used to provide power to electronic, electromechanical, electrochemical, and other useful devices. Such cells include batteries such as primary chemical cells and secondary (rechargeable) cells, fuel cells, and various species of capacitors, including ultracapacitors. Increasing the operating power and energy of energy storage devices, including capacitors and batteries, would be desirable for enhancing energy storage, increasing power capability, and broadening real-world use cases.

Energy storage devices including electrode films combining complimentary attributes may increase energy storage device performance in real-world applications. Furthermore, existing methods of fabrication may impose a practical limit to various structural electrode properties. Thus, new electrode film formulations, and methods for their fabrication, may result in improved performance. Additionally, novel combinations of electrode films may reveal combinations that provide improved performance to an energy storage device.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, a lithium ion battery including at least one self-supporting dry electrode film and having enhanced performance is provided. The enhanced performance may be enhanced electrode material loading, active material loading, areal capacity, specific capacity, areal energy density, energy density, specific energy density, or Coulombic efficiency. In some embodiment, such batteries may have a specific energy density of at least 250 Wh/kg, or an energy density of at least 600 Wh/L.

In one aspect a single dry electrode film of an energy storage device is provided. The dry electrode film includes a dry active material. The dry electrode film further includes a dry binder. The dry electrode film further includes wherein the dry electrode film is free-standing, and wherein the dry electrode film is greater than about 110 μm in thickness.

In another aspect a dry electrode film of an energy storage device is provided. The dry electrode film includes a dry active material. The dry electrode film further includes a dry binder. The dry electrode film further includes wherein the dry electrode film is free-standing, and wherein the dry electrode film is at least 1.4 g/cm³ in electrode film density.

In another aspect a method is provided for fabricating a single dry electrode film of an energy storage device. The method includes providing a dry active material. The method further includes providing a dry binder. The method further includes combining the dry active material and dry binder to provide an electrode film mixture. The method further includes forming a free-standing dry electrode film with a thickness of greater than about 110 μm from the electrode film mixture.

In another aspect a method is provided for fabricating a dry electrode film of an energy storage device. The method includes providing a dry active material. The method further includes providing a dry binder. The method further includes combining the dry active material and dry binder to provide an electrode film mixture. The method further includes forming a free-standing dry electrode film with an electrode film density of at least 1.4 g/cm³ from the electrode film mixture.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 depicts an embodiment of an energy storage device.

FIGS. 2A-2D depict various configurations of energy storage devices which combine dry and wet anodes and cathodes.

FIG. 3A depicts a bipolar electrode in which an anode and a cathode are coupled by a current collector. FIGS. 3B-3E depict various configurations of bipolar electrodes including wet and/or dry electrode films coupled by a current collector.

FIGS. 4A-4E depict various energy storage device cell configurations.

FIGS. 5A and 5B provide capacity and efficiency data, respectively, for lithium ion batteries including various combinations of dry and wet electrodes. Type 1 includes a dry cathode and dry anode, Type 2 includes a dry cathode and a wet anode, Type 3 includes a wet cathode and a dry anode, and Type 4 includes a wet cathode and a wet anode.

FIG. 6 provides voltage vs. capacity data for lithium ion batteries having various combinations of dry and wet electrodes. Type 1 includes a dry cathode and dry anode, Type 2 includes a dry cathode and a wet anode, Type 3 includes a wet cathode and a dry anode, and Type 4 includes a wet cathode and a wet anode.

FIG. 7 provides volumetric energy density (Wh/L) and gravimetric energy density (Wh/kg) data for lithium ion batteries having various combinations of dry and wet electrodes. Type 1 includes a dry cathode and dry anode, Type 2 includes a dry cathode and a wet anode, Type 3 includes a wet cathode and a dry anode, and Type 4 includes a wet cathode and a wet anode.

FIGS. 8A and 8B provide capacity and efficiency data, respectively, for dry lithium ion battery anodes processed in multiple sequential steps (“Mixing A”), and in one step (“Mixing B”).

FIGS. 9A and 9B provide capacity and efficiency data, respectively, for dry lithium ion battery anodes processed in a blade blender (“Mixer A”), and in an acoustic resonant mixer (“Mixer B”).

FIGS. 10A and 10B provide capacity and efficiency data, respectively, for dry lithium ion battery anodes processed using non-pre-milled polymer binder (“Process A”) and pre-milled polymer binder processed through a jet mill prior to the introduction of the remaining electrode components (“Process B”).

FIGS. 11A and 11B provide capacity and efficiency data, respectively, for dry lithium ion battery anodes processed using active material that was processed using a jet-milling step, with binder that was also processed using a jet-milling step (“Formula 1”), and using active material that was processed using a gentle powder process, with binder that was processed using a jet-milling step (“Formula 4”).

FIG. 12 provides voltage vs. capacity data for a dry coated thick NMC622 cathode half-cell.

FIG. 13 provides voltage vs. capacity data for a dry coated thick graphite anode half-cell.

FIG. 14 provides the first cycle electrochemical results for a dry coated thick NMC622 cathode half-cell at various electrode material loading weights.

FIGS. 15A and 15B provide full-cell discharge rate voltage profiles for dry and wet coated thick electrodes, respectively.

FIG. 16 provides the discharge capacity of the full-cell dry and wet coated thick electrodes shown in FIGS. 15A and 15B at varying current rates.

FIGS. 17A and 17B provide full-cell charge rate voltage profiles for dry and wet coated thick electrodes, respectively.

FIG. 18 provides the charge capacity of the full-cell dry and wet coated thick electrodes shown in FIGS. 17A and 17B at varying current rates.

FIGS. 19A and 19B provide electrochemical impedance spectroscopy data for dry coated thick electrodes in pouch full-cells before and after aging, respectively.

FIGS. 19C and 19D provide electrochemical impedance spectroscopy data for wet coated thick electrodes in pouch full-cells before and after aging, respectively.

FIG. 20 provides cell voltages for dry and wet coated thick electrodes in pouch full-cells before and after aging.

FIG. 21 provides cell capacity retentions for dry and wet coated thick electrodes in pouch full-cells after aging.

FIG. 22 provides electrode film density vs. loading of a traditional dry processed electrode.

FIG. 23 provides capacity vs. electrode film density for different dry electrode formulations produced by the presently disclosed dry process, compared to a prior art wet coated process.

FIGS. 24A and 24B provide gravimetric energy densities and volumetric energy densities, respectively, relative to loadings for the graphite anodes created according to the present disclosure.

### DETAILED DESCRIPTION

Provided herein are various embodiments of energy storage devices having improved performance. In particular, in certain embodiments, energy storage devices disclosed herein include electrode films having high energy density. The energy storage devices incorporate electrode films fabricated using improved techniques, and by combinations of various processes. The energy storage devices may be lithium ion based batteries.

Lithium ion batteries have been relied on as a power source in numerous commercial and industrial uses, for example, in consumer devices, productivity devices, and in battery powered vehicles. However, demands placed on energy storage devices are continuously—and rapidly—growing. For example, the automotive industry is developing vehicles that rely on compact and efficient energy storage, such as plug-in hybrid vehicles and pure electric vehicles. Lithium ion batteries are well suited to meet future demands however improvements in energy density are needed to provide longer life batteries that can travel further on a single charge. Thus, there is a need for energy storage devices in general, and lithium ion batteries in particular, capable of providing higher energy storage or density per size relative to, for example, the mass and/or volume of the device.

Key components of the storage potential of an energy storage device are the electrodes, and more specifically, the electrode films comprising each electrode. The electrochemical capabilities of electrodes, for example, the capacity and efficiency of battery electrodes, is governed by various factors. For example, distribution of active material, binder and additive(s); the physical properties of materials therein, such as particle size and surface area of active material; the surface properties of the active materials; and the physical characteristics of the electrode film, such as cohesiveness, and adhesiveness to a conductive element.

In principle, a thicker electrode film is advantageous because, as the electrode film gets thicker, more active materials are present relative to other, non-energy-storing components, of a device. A thicker electrode film may be realized as loading of electrode materials per unit area of a current collector, or alternatively as capacity or energy density per unit area of electrode film. However, thicker electrode films test the practical limits of electrode film fabrication techniques.

Generally, electrode films may suffer reduced performance due to the mechanical properties of the film components, and interactions therebetween. For example, it is thought that mechanical limitations may result from poor adhesion between an active layer and a current collector, and poor cohesion in the electrode film, for example, between active materials and binders. Such processes may lead to losses in performance in both power delivery and energy storage capacity. It is thought that losses in performance may be due to deactivation of active materials, for example, due to losses in ionic conductivity, in electrical conductivity, or a combination thereof. For example, as adhesion between active layers and current collectors decrease, cell resistance may increase. Decreases in cohesion between active materials may also lead to increases in cell resistance, and in some cases electrical contact may be lost, removing some active material from the ionic and electrical transfer cycles in the cell. Without being limited by theory, it is thought that volumetric changes in the active materials may contribute to such processes. For example, additional degradation may be observed in electrodes incorporating certain active materials, such as silicon-based materials, that undergo significant volumetric changes during cell cycling. Lithium intercalation-deintercalation processes may correspond to such volumetric changes in some systems. Generally, these mechanical degradation processes may be observed in any electrode, for example a cathode, an anode, a positive electrode, a negative electrode, a battery electrode, a capacitor electrode, a hybrid electrode, or other energy storage device electrode.

Classical slurry coated wet battery electrodes suffer from some undesired issues such as cracking, delamination and poor flexibility, which are exacerbated in thicker electrode films. As an electrode film gets thicker, which generally corresponds to higher electrode material loading, loss of electrochemical performance and reliability may be observed in wet processed electrodes. Wet processes may suffer from limited material choice, and the resulting wet processed electrode films may also suffer from a non-uniform dispersion of constituent materials, for example, active materials. The non-uniformity may be exacerbated as film thickness and/or density is increased, and may result in poor ionic and/or electrical conductivity. Wet processes also generally require expensive and time-consuming drying steps, which become more difficult as the film becomes thicker. Thus, the thickness of an electrode film produced by a wet process may also be limited. Furthermore, in wet, for example, slurry-based, film-forming processing such as spraying, chemical bath deposition, slot die, extrusion, and printing, the possible configurations of electrode films may be limited.

Embodiments include batteries including an electrode made by a dry process that have a specific energy density of at least 250 Wh/kg, or an energy density of at least 600 Wh/L. Embodiments include dry electrode formulations and fabrication processes that achieve electrode films having a higher density of active materials, a greater electrode film thickness, a higher electrode film density, and/or a higher electronic density (for example, such as energy density, specific energy density, areal energy density, areal capacity and/or specific capacity). An electrode film with a higher electrode film density will generally include more active materials in a smaller electrode film volume. Specifically, smaller particle sizes and more intimate contact of active materials, binders, and additives may be realized in dry electrode processing. Dry electrode processing methods traditionally used a high shear and/or high pressure processing step to break up and commingle electrode film materials, which may contribute to the structural advantages. In some embodiments, such dry electrode processes may enable electrode films with substantially higher electrode densities (about 1.55 g/cm³) and lower electrode porosities (about 26%) with high loadings compared to conventional wet slurry cast and compressed electrode process densities (about 1.3 g/cm³ or less) and porosities (about 37% or more). However, as seen in FIG. 22, electrodes made from traditional dry electrode processes provide electrode films with decreasing densities as electrode material loading is increased, which limit energy and power densities in high loading electrode cells. Some embodiments of the present disclosure provide dry fabrication methods and formulations for controlling electrode film densities (about 1.79 g/cm³) and porosities (about 16%) independently of electrode loading. Formulations are modified by varying electrode material compositions, such as varying active materials, polymer binders and additives. Fabrication methods are modified through dry coating process parameters, such as calendering temperature, calendering pressure, calender roll gap, and number of passes. Embodiments utilizing such processes and compositions show significantly improved electrode film density at high loadings. In some embodiments, calendering may be performed at about ambient temperature. In some embodiments, high loadings and high electrode film densities are achieved without defects such as cracking and/or delamination of the electrode.

A dry or self-supporting electrode film as provided herein may provide improved characteristics relative to a typical electrode film. For example, a dry or self-supporting electrode film as provided herein may provide one or more of improved material loading or electrode material loading (which may be expressed as mass of electrode film per unit area of electrode film or current collector), improved active material loading (which may be expressed as mass of active material per unit area of electrode film or current collector), improved areal capacity (which may be expressed as capacity per unit area of electrode film or current collector), improved areal energy density (which may be expressed as energy per unit area of electrode film or current collector), improved specific energy density (which may be expressed as energy per unit mass of electrode film), or improved energy density (which may be expressed as energy per unit volume of electrode film). For further example, a dry or self-supporting electrode film as provided herein may provide improved Coulombic efficiency.

Some embodiments provide an energy storage device exhibiting improved Coulombic efficiency relative to an energy storage device constructed using typical materials and fabrication processes. In particular, the first cycle efficiency of a lithium ion battery including at least one dry process and/or self-supporting electrode as provided herein may be improved. For example, first cycle columbic efficiency during electrochemical cycling may be improved.

An energy storage device described herein may advantageously be characterized by reduced rise in equivalent series resistance over the life of the device, which may provide a device with increased power density over the life of the device. In some embodiments, energy storage devices described herein may be characterized by reduced loss of capacity over the life of the device. Further improvements that may be realized in various embodiments include improved cycling performance, including improved storage stability during cycling, and reduced capacity fade.

In some embodiments, dry process battery electrodes may be coupled with conventional slurry coated wet battery electrodes to provide improved performance of batteries including a dry electrode. In particular, in some embodiments the improved performance of the self-supporting dry cathode, wet anode pair may be realized.

In some embodiments, an energy storage device, such as a lithium ion battery, includes a cathode comprising a self-supporting dry electrode film, and an anode comprising a self-supporting dry electrode film, wherein the energy storage device has one or more additional characteristics provided herein. In further embodiments, an energy storage device includes a cathode comprising a self-supporting dry electrode film, and wherein the energy storage device has one or more other performance characteristics provided herein. In still further embodiments, an energy storage device, such as a lithium ion battery, includes a cathode comprising a self-supporting dry electrode film, and an anode comprising a wet process electrode film, wherein the energy storage device has one or more additional performance characteristics provided herein. Several combinations of wet and dry electrodes can be envisioned, as seen in Table 1.

TABLE 1

| | Cathode | Anode |
|---|---|---|
| Type 1 | Dry | Dry |
| Type 2 | Dry | Wet |
| Type 3 | Wet | Dry |
| Type 4 | Wet | Wet |

Wherein in Table 1, “Dry” refers to a self-supporting electrode film (having the composition of an anode or cathode as indicated) prepared by a dry process, and “Wet” refers to an electrode film (having the composition of an anode or cathode as indicated) prepared by a slurry process.

Some embodiments relate to dry electrode processing techniques. In one embodiment, dry powder mixing conditions (i.e. sequence, intensity and time), mixing methods such as grinding and milling, and formulation development (i.e. active material, additive, binder) have resulted in improved electrochemical performance of the resulting dry battery electrode. Improvement may be realized relative to conventional dry electrode fabrication processes, as disclosed in one or more of U.S. Publication No. 2006/0114643, U.S. Publication No. 2006/0133013, U.S. Pat. No. 9,525,168, or 7,935,155, each of which is incorporated by reference herein in the entirety.

In various embodiments, a dry powder can be mixed by a mild process using, for example a convection, pneumatic or diffusion mixer as follows: a tumbler with and without mixing media (for example, glass bead, ceramic ball), a paddle mixer, a blade blender or an acoustic mixer. The mild mixing process may be nondestructive with respect to any active materials in the mixture. Without limitation, graphite particles may be preserved of size following the mild mixing process. In further embodiments, the powder mixing sequence and conditions can be varied to improve uniform distribution of active material, binder, and optional additive(s).

Embodiments include electrode films fabricated by various combinations of electrode film processing methods. Some examples of electrode formulation that consists of processed active material and binder are listed in the Table 2. Process A includes mild powder processing such as for example, tumbling, blending, or acoustic mixing, and Process B includes intense powder processing such as in a Waring blender, by jet milling or by grinding.

TABLE 2

| | |
|---|---|
| Active material | Binder |

| | Process A | Process B | Process A | Process B |
|---|---|---|---|---|
| Formula 1 | | X | | X |
| Formula 2 | | X | X | |
| Formula 3 | | X | | |
| Formula 4 | X | | | X |
| Formula 5 | X | | X | |
| Formula 6 | X | X | X | |
| Formula 7 | X | X | | X |
| Formula 8 | X | | X | X |
| Formula 9 | X | X | X | X |

The materials and methods provided herein can be implemented in various energy storage devices. As provided herein, an energy storage device can be a capacitor, a lithium ion capacitor (LIC), an ultracapacitor, a battery, or a hybrid energy storage device combining aspects of two or more of the foregoing. In preferable embodiments, the device is a battery.

An energy storage device as provided herein can be of any suitable configuration, for example planar, spirally wound, button shaped, or pouch. An energy storage device as provided herein can be a component of a system, for example, a power generation system, an uninterruptible power source systems (UPS), a photo voltaic power generation system, an energy recovery system for use in, for example, industrial machinery and/or transportation. An energy storage device as provided herein may be used to power various electronic device and/or motor vehicles, including hybrid electric vehicles (HEV), plug-in hybrid electric vehicles (PHEV), and/or electric vehicles (EV).

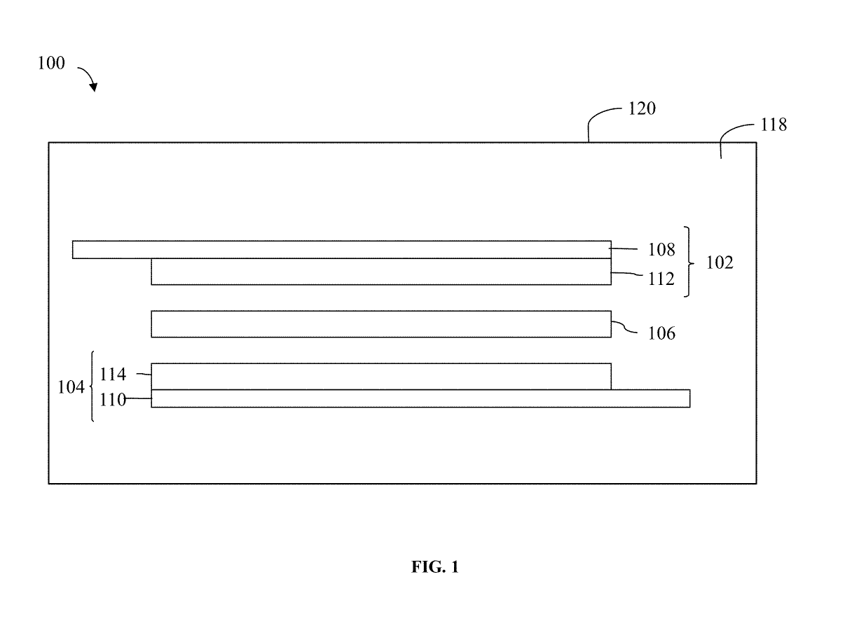

FIG. 1 shows a side cross-sectional schematic view of an example of an energy storage device 100 with an electrode film with a high electrode film density and/or high electronic density. The energy storage device 100 may be classified as, for example, a capacitor, a battery, a capacitor-battery hybrid, or a fuel cell. In some embodiments, device 100 is a lithium ion battery.

The device has a first electrode 102, a second electrode 104, and a separator 106 positioned between the first electrode 102 and second electrode 104. The first electrode 102 and the second electrode 104 are adjacent to respective opposing surfaces of the separator 106. The energy storage device 100 includes an electrolyte 118 to facilitate ionic communication between the electrodes 102, 104 of the energy storage device 100. For example, the electrolyte 118 may be in contact with the first electrode 102, the second electrode 104 and the separator 106. The electrolyte 118, the first electrode 102, the second electrode 104, and the separator 106 are housed within an energy storage device housing 120.

One or more of the first electrode 102, the second electrode 104, and the separator 106, or constituent thereof, may comprise porous material. The pores within the porous material can provide containment for and/or increased surface area for contact with an electrolyte 118 within the housing 120. The energy storage device housing 120 may be sealed around the first electrode 102, the second electrode 104 and the separator 106, and may be physically sealed from the surrounding environment.

In some embodiments, the first electrode 102 can be an anode (the “negative electrode”) and the second electrode 104 can be the cathode (the “positive electrode”). The separator 106 can be configured to electrically insulate two electrodes adjacent to opposing sides of the separator 106, such as the first electrode 102 and the second electrode 104, while permitting ionic communication between the two adjacent electrodes. The separator 106 can comprise a suitable porous, electrically insulating material. In some embodiments, the separator 106 can comprise a polymeric material. For example, the separator 106 can comprise a cellulosic material (e.g., paper), a polyethylene (PE) material, a polypropylene (PP) material, and/or a polyethylene and polypropylene material.

Generally, the first electrode 102 and second electrode 104 each comprise a current collector and an electrode film. Electrodes 102 and 104 comprise high density electrode films 112 and 114 with high electrode film densities and/or high electronic densities, respectively. Electrodes 102 and 104 each have a single electrode film 112 and 114 as shown, but other combinations with two or more electrode films for each electrode 102 and 104 are possible. Device 100 is shown with a single electrode 102 and a single electrode 104, but other combinations are possible. High density electrode films 112 and 114 can each have any suitable shape, size and thickness. For example, the electrode films can each have a thickness of about 30 microns (μm) to about 250 microns, for example, about, or at least about 50 microns, about 100 microns, about 150 microns, about 200 microns, about 250 microns, about 300 microns, about 400 microns, about 500 microns, about 750 microns, about 1000 microns, about 2000 microns, or any range of values therebetween. Further electrode film thicknesses are described throughout the disclosure, for a single electrode film. The electrode films generally comprise one or more active materials, for example, anode active materials or cathode active materials as provided herein. The electrode films 112 and/or 114 may be dry and/or self-supporting electrode films as provided herein, and having advantageous properties, such as thickness, increased electrode film density, energy density, specific energy density, areal energy density, areal capacity or specific capacity, as provided herein. The first electrode film 112 and/or the second electrode film 114 may also include one or more binders as provided herein. The electrode films 112 and/or 114 may be prepared by a process as described herein. The electrode films 112 and/or 114 may be wet or self-supporting dry electrodes as described herein.

As shown in FIG. 1, the first electrode 102 and the second electrode 104 include a first current collector 108 in contact with first high density electrode film 112, and a second current collector 110 in contact with the second high density electrode film 114, respectively. The first current collector 108 and the second current collector 110 facilitate electrical coupling between each corresponding electrode film and an external electrical circuit (not shown). The first current collector 108 and/or the second current collector 110 comprise one or more electrically conductive materials, and have can have any suitable shape and size selected to facilitate transfer of electrical charge between the corresponding electrode and an external circuit. For example, a current collector can include a metallic material, such as a material comprising aluminum, nickel, copper, rhenium, niobium, tantalum, and noble metals such as silver, gold, platinum, palladium, rhodium, osmium, iridium and alloys and combinations of the foregoing. For example, the first current collector 108 and/or the second current collector 110 can comprise, for example, an aluminum foil or a copper foil. The first current collector 108 and/or the second current collector 110 can have a rectangular or substantially rectangular shape sized to provide transfer of electrical charge between the corresponding electrode and an external circuit.

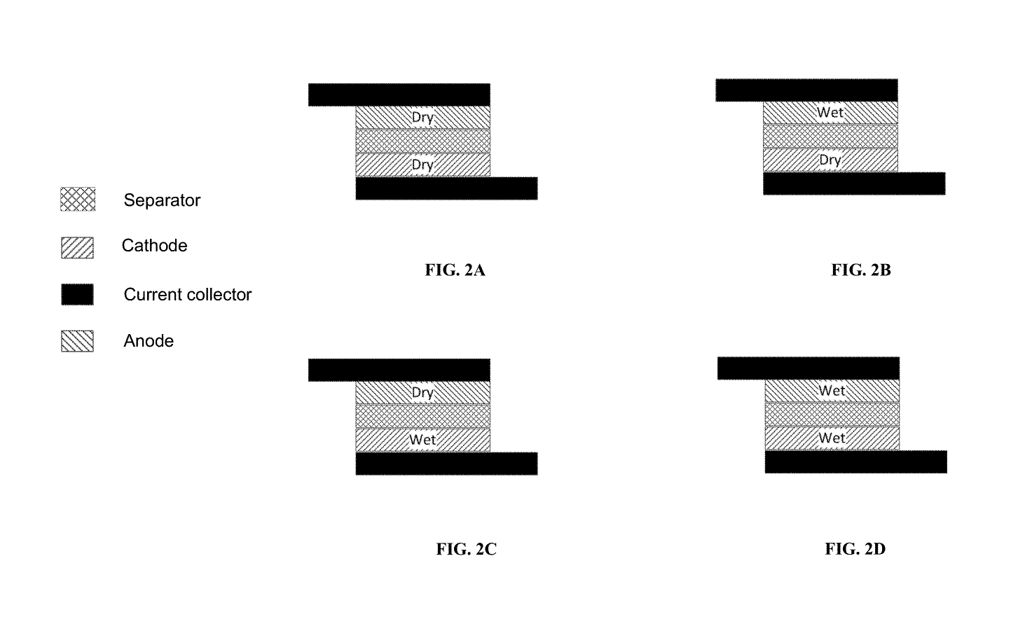

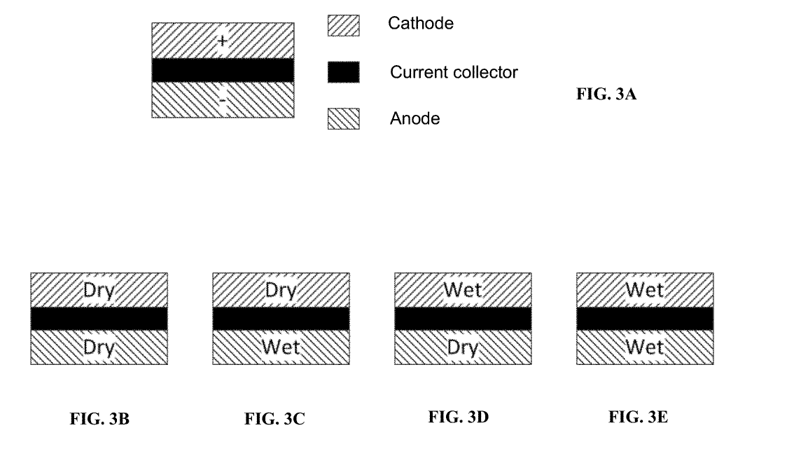

Various embodiments of electrode configurations, for example, of energy storage device 100, are presented in FIGS. 2A-2D. In FIG. 2A, an energy storage device including a dry anode and a dry cathode is depicted. In FIG. 2B, an energy storage device including a wet anode and a dry cathode is depicted. In FIG. 2C, an energy storage device including a dry anode and a wet cathode is depicted. In FIG. 2D, a comparative energy storage device including a wet anode and wet cathode is depicted. FIG. 3A depicts a generic bipolar electrode. FIGS. 3B-3E depict various configurations of bipolar electrodes including dry and/or wet electrode films for use in energy storage devices. FIG. 3B depicts a cell in which a dry anode is coupled with a dry cathode. FIG. 3C depicts a cell in which a wet anode is coupled with a dry cathode. FIG. 3D depicts a cell in which a dry anode is coupled with a wet cathode. FIG. 3E depicts a comparative cell configuration in which a wet anode is coupled with a wet cathode.

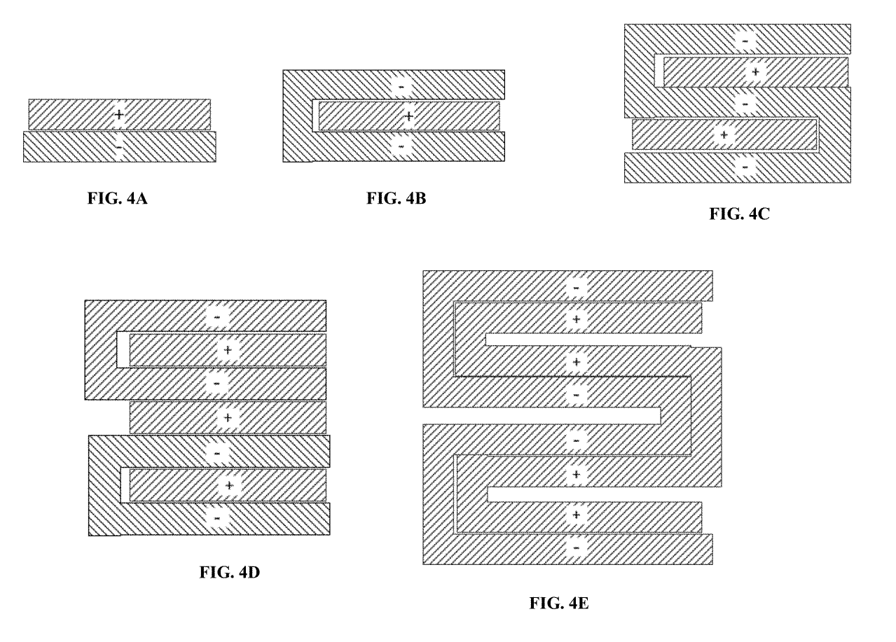

Various battery cell configurations are depicted in FIGS. 4A-4E. For example, in FIG. 4A, a cell is depicted in which the cathode and anode share a single contact area. In FIG. 4B, a cell configuration is depicted in which a cathode share two contact areas with a single anode. In FIG. 4B, the cathode is double-sided cathode, and the cathode may be coated, for example, with a current collector or a material suitable as a separator, on opposing surfaces. In FIG. 4C, a cell configuration is depicted in which a single anode shares two contact areas with each of two discrete cathodes. In FIG. 4C, each of the two cathodes are double sided cathodes, wherein each cathode may be coated, for example, with a current collector or a material suitable as a separator, on opposing surfaces. In FIG. 4D, two anodes share two contact areas with each of two discrete cathodes, while a third discrete cathode shares a contact area with each of the two anodes. In FIG. 4E, a cell configuration is depicted in which a single anode shares a single contact area with a single cathode, but the electrode pair is folded on itself. In some embodiments, an energy storage device may have the configuration depicted in any one of FIGS. 4A to 4E. In further embodiments, an energy storage device may have a configuration that combines aspects, in any combination, of those depicted in FIGS. 4A to 4E. For example, an energy storage device may include cells, at least one of which has a configuration depicted in one of FIGS. 4A to 4E, and at least one other cell that has a configuration depicted in another of FIGS. 4A to 4E. Furthermore, an energy storage device may have an electrode of one of FIGS. 4A to 4E in ionic contact (e.g., separated by a separator impregnated with a suitable electrolyte as described herein) or in electrical contact (e.g., coupled by a current collector) with an electrode having the configuration of another of FIGS. 4A to 4E.

In some embodiments, the at least one active material includes a treated carbon material, where the treated carbon material includes a reduction in a number of hydrogen-containing functional groups, nitrogen-containing functional groups and/or oxygen-containing functional groups, as described in U.S. Patent Publication No. 2014/0098464. For example, the treated carbon particles can include a reduction in a number of one or more functional groups on one or more surfaces of the treated carbon, for example about 10% to about 60% reduction in one or more functional groups compared to an untreated carbon surface, including about 20% to about 50%. The treated carbon can include a reduced number of hydrogen-containing functional groups, nitrogen-containing functional groups, and/or oxygen-containing functional groups. In some embodiments, the treated carbon material comprises functional groups less than about 1% of which contain hydrogen, including less than about 0.5%. In some embodiments, the treated carbon material comprises functional groups less than about 0.5% of which contains nitrogen, including less than about 0.1%. In some embodiments, the treated carbon material comprises functional groups less than about 5% of which contains oxygen, including less than about 3%. In further embodiments, the treated carbon material comprises about 30% fewer hydrogen-containing functional groups than an untreated carbon material.

In some embodiments, energy storage device 100 can be a lithium ion battery. In some embodiments, the electrode film of a lithium ion battery electrode can comprise one or more active materials, and a fibrillized binder matrix as provided herein.

In further embodiments, the energy storage device 100 is charged with a suitable lithium-containing electrolyte. For example, device 100 can include a lithium salt, and a solvent, such as a non-aqueous or organic solvent. Generally, the lithium salt includes an anion that is redox stable. In some embodiments, the anion can be monovalent. In some embodiments, a lithium salt can be selected from hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(oxalate)borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, or any range of values therebetween.

In some embodiments, an energy storage device electrolyte as provided herein can include a liquid solvent. A solvent as provided herein need not dissolve every component, and need not completely dissolve any component, of the electrolyte. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise LiPF₆, and one or more carbonates.

In some embodiments, the lithium ion battery is configured to operate at about 2.5 to 4.5 V, or 3.0 to 4.2 V. In further embodiments, the lithium ion battery is configured to have a minimum operating voltage of about 2.5 V to about 3 V, respectively. In still further embodiments, the lithium ion battery is configured to have a maximum operating voltage of about 4.1 V to about 4.4 V, respectively.

In some embodiments, a method for fabricating an energy storage device is provided. In further embodiments, the method comprises selecting an anode and a cathode. In some embodiments, selecting the anode comprises selecting a dry self-supporting anode or a wet anode. In further embodiments, selecting the cathode comprises selecting a dry self-supporting cathode or a wet cathode. The step of selecting a dry anode may comprise selecting an active material processing method, and selecting a binder processing method.

In some embodiments, an electrode film as provided herein includes at least one active material and at least one binder. The at least one active material can be any active material known in the art. The at least one active material may be a material suitable for use in the anode or cathode of a battery. Anode active materials can comprise, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx).

The cathode active material, can comprise, for example, a metal oxide, metal sulfide, or a lithium metal oxide. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate (LTO), and/or a lithium nickel cobalt aluminum oxide (NCA). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)) or an olivine (such as LiFePO₄). The cathode active material can comprise sulfur or a material including sulfur, such as lithium sulfide (Li2S), or other sulfur-based materials, or a mixture thereof. In some embodiments, the cathode film comprises a sulfur or a material including sulfur active material at a concentration of at least 50 wt %. In some embodiments, the cathode film comprising a sulfur or a material including sulfur active material has an areal capacity of at least 6 mAh/cm². In some embodiments, the cathode film comprising a sulfur or a material including sulfur active material has an electrode film density of 1 g/cm³. In some embodiments, the cathode film comprising a sulfur or a material including sulfur active material further comprises a binder. In some embodiments, the binder of the cathode film comprising a sulfur or a material including sulfur active material is selected from polytetrafluoroethylene (PTFE), polyvinylidene fluoride (PVDF), polyethylene (PE), other thermoplastics, or any combination thereof.

The at least one active material may include one or more carbon materials. The carbon materials may be selected from, for example, graphitic material, graphite, graphene-containing materials, hard carbon, soft carbon, carbon nanotubes, porous carbon, conductive carbon, or a combination thereof. Activated carbon can be derived from a steam process or an acid/etching process. In some embodiments, the graphitic material can be a surface treated material. In some embodiments, the porous carbon can comprise activated carbon. In some embodiments, the porous carbon can comprise hierarchically structured carbon. In some embodiments, the porous carbon can include structured carbon nanotubes, structured carbon nanowires and/or structured carbon nanosheets. In some embodiments, the porous carbon can include graphene sheets. In some embodiments, the porous carbon can be a surface treated carbon.

In some embodiments, a cathode electrode film of a lithium ion battery or hybrid energy storage device can include about 70 weight % to about 98 weight % of the at least one active material, including about 70 weight % to about 92 weight %, or about 70 weight % to about 96 weight %. In some embodiments, a cathode electrode film can comprise about or up to about 70 weight %, about or up to about 90 weight %, about or up to about 92 weight %, about 94 weight %, about 95 weight %, about or up to about 96 weight % or about or up to about 98 weight % of the at least one active material, or any range of values therebetween. In some embodiments, a cathode electrode film of a lithium ion battery or hybrid energy storage device can include about 40 weight % to about 60 weight % of the at least one active material. In some embodiments, the cathode electrode film can comprise up to about 10 weight % of the porous carbon material, including up to about 5 weight %, or about 1 weight % to about 5 weight %. In some embodiments, the cathode electrode film can comprise about or up to about 10 weight %, about or up to about 5 weight %, about or up to about 1 weight % or about or up to about 0.5 weight % of the porous carbon material, or any range of values therebetween. In some embodiments, the cathode electrode film comprises up to about 5 weight %, including about 1 weight % to about 3 weight %, of the conductive additive. In some embodiments, the cathode electrode film comprises about or up to about 10 weight %, 5 weight %, about or up to about 3 weight % or about or up to about 1 weight % of the conductive additive, or any range of values therebetween. In some embodiments, the cathode electrode film comprises up to about 20 weight % of the binder, for example, about 1.5 weight % to 10 weight %, about 1.5 weight % to 5 weight %, or about 1.5 weight % to 3 weight %. In some embodiments, the cathode electrode film comprises about 1.5 weight % to about 3 weight % binder. In some embodiments, the cathode electrode film comprises about or up to about 20 weight %, about or up to about 15 weight %, about or up to about 10 weight %, about or up to about 5 weight %, about or up to about 3 weight %, about or up to about 1.5 weight % or about or up to about 1 weight % of the binder, or any range of values therebetween.

In some embodiments, an anode electrode film may comprise at least one active material, a binder, and optionally a conductive additive. In some embodiments, the conductive additive may comprise a conductive carbon additive, such as carbon black. In some embodiments, the at least one active material of the anode may comprise synthetic graphite, natural graphite, hard carbon, soft carbon, graphene, mesoporous carbon, silicon, silicon oxides, tin, tin oxides, germanium, lithium titanate, mixtures, or composites of the aforementioned materials. In some embodiments, an anode electrode film can include about 80 weight % to about 98 weight % of the at least one active material, including about 80 weight % to about 98 weight %, or about 94 weight % to about 97 weight %. In some embodiments, an anode electrode film can include about 80 weight %, about 85 weight %, about 90 weight %, about 92 weight %, about 94 weight %, about 95 weight %, about 96 weight %, about 97 weight % or about 98 weight % or about 99 weight % of the at least one active material, or any range of values therebetween. In some embodiments, the anode electrode film comprises up to about 5 weight %, including about 1 weight % to about 3 weight %, of the conductive additive. In some embodiments, the anode electrode film comprises about or up to about 5 weight %, about or up to about 3 weight %, about or up to about 1 weight % or about or up to about 0.5 weight % of the conductive additive, or any range of values therebetween. In some embodiments, the anode electrode film comprises up to about 20 weight % of the binder, including about 1.5 weight % to 10 weight %, about 1.5 weight % to 5 weight %, or about 3 weight % to 5 weight %. In some embodiments, the anode electrode film comprises about 4 weight % binder. In some embodiments, the anode electrode film comprises about or up to about 20 weight %, about or up to about 15 weight %, about or up to about 10 weight %, about or up to about 5 weight %, about or up to about 3 weight %, about or up to about 1.5 weight % or about or up to about 1 weight % of the binder, or any range of values therebetween. In some embodiments, the anode film may not include a conductive additive.

Some embodiments include an electrode film, such as of an anode and/or a cathode, having one or more active layers comprising a polymeric binder material. The binder can include polytetrafluoroethylene (PTFE), a polyolefin, polyalkylenes, polyethers, styrene-butadiene, co-polymers of polysiloxanes and polysiloxane, branched polyethers, polyvinylethers, co-polymers thereof, and/or admixtures thereof. The binder can include a cellulose, for example, carboxymethylcellulose (CMC). In some embodiments, the polyolefin can include polyethylene (PE), polypropylene (PP), polyvinylidene fluoride (PVDF), co-polymers thereof, and/or mixtures thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. In some embodiments, the binder may be a thermoplastic. In some embodiments, the binder comprises a fibrillizable polymer. In certain embodiments, the binder comprises, consists essentially, or consists of PTFE.

In some embodiments, the binder may comprise PTFE and optionally one or more additional binder components. In some embodiments, the binder may comprise one or more polyolefins and/or co-polymers thereof, and PTFE. In some embodiments, the binder may comprise a PTFE and one or more of a cellulose, a polyolefin, a polyether, a precursor of polyether, a polysiloxane, co-polymers thereof, and/or admixtures thereof. An admixture of polymers may comprise interpenetrating networks of the aforementioned polymers or co-polymers.

The binder may include various suitable ratios of the polymeric components. For example, PTFE can be up to about 98 weight % of the binder, for example, from about 20 weight % to about 95 weight %, about 20 weight % to about 90 weight %, including about 20 weight % to about 80 weight %, about 30 weight % to about 70 weight %, about 30 weight % to about 50 weight %, or about 50 weight % to about 90 weight %. In some embodiments, PTFE can be about or up to about 99 weight %, about or up to about 98 weight %, about or up to about 95 weight %, about or up to about 90 weight %, about or up to about 80 weight %, about or up to about 70 weight %, about or up to about 60 weight %, about or up to about 50 weight %, about or up to about 40 weight %, about or up to about 30 weight % or about or up to about 20 weight % of the binder, or any range of values therebetween. In some embodiments, the binder can consistent essentially of or consist of PTFE.

In some embodiments, the electrode film mixture may include binder particles having selected sizes. In some embodiments, the binder particles may be about 50 nm, about 100 nm, about 150 nm, about 200 nm, about 250 nm, about 300 nm, about 350 nm, about 400 nm, about 450 nm, about 500 nm, about 1 μm, about 2 μm, about 3 μm, about 4 μm, about 5 μm, about 10 μm, about 50 μm, about 100 μm, or any range of values therebetween.

As used herein, a dry fabrication process can refer to a process in which no or substantially no solvents are used in the formation of an electrode film. For example, components of the active layer or electrode film, including carbon materials and binders, may comprise dry particles. The dry particles for forming the active layer or electrode film may be combined to provide a dry particle active layer mixture. In some embodiments, the active layer or electrode film may be formed from the dry particle active layer mixture such that weight percentages of the components of the active layer or electrode film and weight percentages of the components of the dry particles active layer mixture are substantially the same. In some embodiments, the active layer or electrode film formed from the dry particle active layer mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the dry particle mixture. A process for forming an active layer or electrode film can include fibrillizing the fibrillizable binder component(s) such that the film comprises fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

In some embodiments, an energy storage device electrode film, wherein the electrode film is dry and/or self-supporting film, may provide a high electrode material loading, or a high active material loading (which may be expressed as mass of electrode film per unit area of electrode film or current collector) of about 12 mg/cm², about 13 mg/cm², about 14 mg/cm², about 15 mg/cm², about 16 mg/cm², about 17 mg/cm², about 18 mg/cm², about 19 mg/cm², about 20 mg/cm², about 21 mg/cm², about 22 mg/cm², about 23 mg/cm², about 24 mg/cm², about 25 mg/cm², about 26 mg/cm², about 27 mg/cm², about 28 mg/cm², about 29 mg/cm², about 30 mg/cm², about 40 mg/cm², about 50 mg/cm², about 60 mg/cm², about 70 mg/cm², about 80 mg/cm², about 90 mg/cm² or about 100 mg/cm², or any range of values therebetween. In some embodiments, an energy storage device electrode film, wherein the electrode film is dry and/or self-supporting film, may provide a high electrode material loading, or a high active material loading (which may be expressed as mass of electrode film per unit area of electrode film or current collector) of at least about 12 mg/cm², at least about 13 mg/cm², at least about 14 mg/cm², at least about 15 mg/cm², at least about 16 mg/cm², at least about 17 mg/cm², at least about 18 mg/cm², at least about 19 mg/cm², at least about 20 mg/cm², at least about 21 mg/cm², at least about 22 mg/cm², at least about 23 mg/cm², at least about 24 mg/cm², at least about 25 mg/cm², at least about 26 mg/cm², at least about 27 mg/cm², at least about 28 mg/cm², at least about 29 mg/cm², at least about 30 mg/cm², at least about 40 mg/cm², at least about 50 mg/cm², at least about 60 mg/cm², at least about 70 mg/cm², at least about 80 mg/cm², at least about 90 mg/cm² or at least about 100 mg/cm², or any range of values therebetween.

An electrode film may have a selected thickness suitable for certain applications. The thickness of an electrode film as provided herein may be greater than that of an electrode film prepared by conventional processes. In some embodiments, the electrode film can have a thickness of about, or greater than about, 110 microns, about 115 microns, about 120 microns, about 130 microns, about 135 microns, about 150 microns, about 155 microns, about 160 microns, about 170 microns, about 200 microns, about 250 microns, about 260 microns, about 265 microns, about 270 microns, about 280 microns, about 290 microns, about 300 microns, about 350 microns, about 400 microns, about 450 microns, about 500 microns, about 750 microns, about 1 mm, or about 2 mm, or any range of values therebetween. An electrode film thickness can be selected to correspond to a desired areal capacity, specific capacity, areal energy density, energy density, or specific energy density.

In some embodiments, the electrode film porosity of an electrode film as provided herein may be greater than that of an electrode film prepared by conventional processes. In some embodiments, the electrode film porosity of an electrode film as provided herein may be less than that of an electrode film prepared by conventional processes. In some embodiments, the electrode film can have an electrode film porosity (which may be expressed as the percentage of volume of electrode film occupied by pores) of about 10%, about 12%, about 14%, about 16%, about 18% or about 20%, or any range of values therebetween. In some embodiments, the electrode film can have an electrode film porosity (which may be expressed as the percentage of volume of electrode film occupied by pores) of at least about 10%, at least about 12%, at least about 14%, at least about 16%, at least about 18% or at least about 20%, or any range of values therebetween. In some embodiments, the electrode film can have an electrode film porosity (which may be expressed as the percentage of volume of electrode film occupied by pores) of at most about 10%, at most about 12%, at most about 14%, at most about 16%, at most about 18% or at most about 20%, or any range of values therebetween.

In some embodiments, the electrode film density of an electrode film as provided herein may be less than that of an electrode film prepared by conventional processes. In some embodiments, the electrode film density of an electrode film as provided herein may be greater than that of an electrode film prepared by conventional processes. In some embodiments, the electrode film can have an electrode film density of about 0.8 g/cm³, 1.0 g/cm³, 1.4 g/cm³, about 1.5 g/cm³, about 1.6 g/cm³, about 1.7 g/cm³, about 1.8 g/cm³, about 1.9 g/cm³, about 2.0 g/cm³, about 2.5 g/cm³, about 3.0 g/cm³, about 3.3 g/cm³, about 3.4 g/cm³, about 3.5 g/cm³, about 3.6 g/cm³, about 3.7 g/cm³ or about 3.8 g/cm³, or any range of values therebetween. In some embodiments, the electrode film can have an electrode film density of at most about 0.8 g/cm³, 1.0 g/cm³, 1.4 g/cm³, at most about 1.5 g/cm³, at most about 1.6 g/cm³, at most about 1.7 g/cm³, at most about 1.8 g/cm³, at most about 1.9 g/cm³ or at most about 2.0 g/cm³, or any range of values therebetween. In some embodiments, the electrode film can have density of at least about 0.8 g/cm³, 1.0 g/cm³, 1.4 g/cm³, at least about 1.5 g/cm³, at least about 1.6 g/cm³, at least about 1.7 g/cm³, at least about 1.8 g/cm³, at least about 1.9 g/cm³, at least about 2.0 g/cm³, at least about 2.5 g/cm³, at least about 3.0 g/cm³, at least about 3.3 g/cm³, at least about 3.4 g/cm³ or at least about 3.5 g/cm³, or any range of values therebetween.

The electrode formulation may be calendered into an electrode film as provided herein at temperatures lower than conventional processes. In some embodiments, the electrode formulation may be calendered at a temperature of about 20° C., about 23° C., about 25° C., about 30° C., about 35° C., about 40° C., about 50° C., about 60° C., about 65° C., about 90° C., about 120° C., about 150° C., about 170° C. or about 200° C., or any range of values therebetween. In some embodiments, the electrode formulation may be calendered at about ambient or room temperature.

In some embodiments, an energy storage device electrode film, wherein the electrode film is dry and/or self-supporting film, may provide areal capacity (which may be expressed as capacity per unit area of electrode film or current collector) of about, or at least about 3.5 mAh/cm², about 3.8 mAh/cm², about 4 mAh/cm², about 4.3 mAh/cm², about 4.5 mAh/cm², about 4.8 mAh/cm², about 5 mAh/cm², about 5.5 mAh/cm², about 6 mAh/cm², about 6.5 mAh/cm², about 6.6 mAh/cm², about 7 mAh/cm², about 7.5 mAh/cm², about 8 mAh/cm² or about 10 mAh/cm², or any range of values therebetween. In further embodiments, an energy storage device electrode film, wherein the electrode film is dry and/or self-supporting film, may provide areal capacity (which may be expressed as capacity per unit area of electrode film or current collector) of at least about 8 mAh/cm², for example, about 8 mAh/cm², about 10 mAh/cm², about 12 mAh/cm², about 14 mAh/cm², about 16 mAh/cm², about 18 mAh/cm², about 20 mAh/cm², or any range of values therebetween. In some embodiments, the areal capacity is charging capacity. In further embodiments, the areal capacity is discharging capacity.

In some embodiments, a dry and/or self-supporting graphite battery anode electrode film may provide areal capacity of about 3.5 mAh/cm², about 4 mAh/cm², about 4.5 mAh/cm², about 5 mAh/cm², about 5.5 mAh/cm², about 6 mAh/cm², about 6.5 mAh/cm², about 7 mAh/cm², about 7.5 mAh/cm², about 8 mAh/cm², about 8.5 mAh/cm², about 9 mAh/cm², about 10 mAh/cm², or any range of values therebetween. In some embodiments, the areal capacity is charging capacity. In further embodiments, the areal capacity is discharging capacity.

In some embodiments, an energy storage device electrode film, wherein the electrode film is dry and/or self-supporting film, may provide a specific capacity (which may be expressed as capacity per mass of electrode film or current collector) of about 150 mAh/g, about 160 mAh/g, about 170 mAh/g, about 175 mAh/g, about 176 mAh/g, about 177 mAh/g, about 179 mAh/g, about 180 mAh/g, about 185 mAh/g, about 190 mAh/g, about 196 mAh/g, about 200 mAh/g, about 250 mAh/g, about 300 mAh/g, about 350 mAh/g, about 354 mAh/g or about 400 mAh/g, or any range of values therebetween. In further embodiments, an energy storage device electrode film, wherein the electrode film is dry and/or self-supporting film, may provide specific capacity (which may be expressed as capacity per mass of electrode film or current collector) of at least about 175 mAh/g or at least about 250 mAh/g, or any range of values therebetween. In some embodiments, the specific capacity is charging capacity. In further embodiments, the specific capacity is discharging capacity. In some embodiments, the electrode may be an anode and/or a cathode. In some embodiment, the specific capacity may be a first charge and/or discharge capacity. In further embodiments, the specific capacity may be a charge and/or discharge capacity measured after the first charge and/or discharge.

In some embodiments, a self-supporting dry electrode film described herein may advantageously exhibit improved performance relative to a typical electrode film. The performance may be, for example, tensile strength, elasticity (extension), bendability, coulombic efficiency, capacity, or conductivity. In some embodiments, an energy storage device electrode film, wherein the electrode film is dry and/or self-supporting film, may provide a coulombic efficiency (which may be expressed as a percent of the discharge capacity divided by the charge capacity) of about, or at least about, 85%, 86%, 87%, about 88%, about 89%, about 90%, about 91%, about 92%, about 93%, about 94% or about 95%, or any range of values therebetween for example such as 90.1%, 90.5% and 91.9%, or any range of values therebetween.

In some embodiments, an energy storage device electrode film or electrode, wherein the electrode film is or the electrode comprises a dry and/or self-supporting film, may provide a charge capacity retention percentage (which may be expressed by the discharge capacity at a given rate divided by the discharge capacity measured at C/10) of about or at least about 10%, about or at least about 20%, about or at least about 30%, about or at least about 40%, about or at least about 50%, about or at least about 60%, about or at least about 70%, about or at least about 80%, about or at least about 90%, about or at least about 98%, about or at least about 99%, about or at least about 99.9% or about or at least about 100%, or any range of values therebetween. In some embodiments, the discharge rate of the charge capacity retention percentage is about or is at least about C/10, C/5, C/3, C/2, 1C, 1.5C or 2C, or any value therebetween.

In some embodiments, an energy storage device electrode film or electrode, wherein the electrode film is or the electrode comprises a dry and/or self-supporting film, may provide a charge capacity production percentage (which may be expressed by the charge capacity measured at a given constant current rate divided by the discharge capacity measured at C/10) of about or at least about 10%, about or at least about 20%, about or at least about, 30%, about or at least about, 40%, about or at least about 50% about or at least about 60%, about or at least about 70%, about or at least about 80%, about or at least about 90%, about or at least about 98%, about or at least about 99%, about or at least about 99.9% or about or at least about 100%, or any range of values therebetween. In some embodiments, the charge rate of the charge capacity production percentage is or is at least C/10, C/5, C/3, C/2, 1C, 1.5C or 2C, or any value therebetween.

In some embodiments, an energy storage device electrode film, wherein the electrode film is dry and/or self-supporting film, may provide a specific energy density or gravimetric energy density (which may be expressed as energy per mass of electrode film) of about 200 Wh/kg, about 210 Wh/kg, about 220 Wh/kg, about 230 Wh/kg, about 240 Wh/kg, about 250 Wh/kg, about 260 Wh/kg, about 270 Wh/kg, about 280 Wh/kg, about 290 Wh/kg, about 300 Wh/kg, about 400 Wh/kg, about 500 Wh/kg, about 600 Wh/kg, about 650 Wh/kg, about 700 Wh/kg, about 750 Wh/kg, about 800 Wh/kg, about 825 Wh/kg, about 850 Wh/kg or about 900 Wh/kg, or any range of values therebetween.

In some embodiments, an energy storage device electrode film, wherein the electrode film is dry and/or self-supporting film, may provide an energy density or volumetric energy density (which may be expressed as energy per unit volume of the final or in situ electrode film) of about 550 Wh/L, about 600 Wh/L, about 630 Wh/L, about 650 Wh/L, about 680 Wh/L, about 700 Wh/L, about 750 Wh/L, about 850 Wh/L, about 950 Wh/L, about 1100 Wh/L, about 1400 Wh/L, about 1425 Wh/L, about 1450 Wh/L, about 1475 Wh/L, about 1500 Wh/L, about 1525 Wh/L or about 1550 Wh/L, or any range of values therebetween.

In some embodiments, a self-supporting dry battery cathode may exhibit reduced ohmic resistance and/or improved voltage polarization characteristics compared to a wet battery cathode. In further embodiments, a lithium ion battery incorporating a self-supporting dry cathode may advantageously exhibit reduced ohmic resistance and/or improved voltage polarization characteristics compared to a lithium ion battery having a wet cathode and a wet anode. In still further embodiments, a lithium ion battery incorporating a self-supporting dry cathode may demonstrate improved energy density and/or specific energy density, as compared to a lithium ion battery including a wet cathode.

In some embodiments, a self-supporting dry battery electrode after aging may exhibit reduced ohmic resistance, improved voltage polarization characteristics and/or improved capacity compared to an aged wet battery electrode. In some embodiments, the dry battery electrode after aging exhibits a reduction of ohmic resistance that is about 5 fold, about 10 fold, about 15 fold or about 20 fold less than the reduction of ohmic resistance in a similarly aged wet battery electrode, or any range of values therebetween. In some embodiments, the dry battery electrode after aging exhibits reduction of voltage of about 1.5 times, about 2 times, about 3 times or about 5 times less than the reduction of voltage in a similarly aged wet battery electrode, or any range of values therebetween. In some embodiments, the dry battery electrode after aging exhibits reduction of capacity of about 1.5 times, about 2 times, about 3 times or about 5 times less than the reduction of capacity in a similarly aged wet battery electrode, or any range of values therebetween.

In specific examples below, high energy density, high specific energy density, high thickness and/or high electrode film density battery electrodes were fabricated.

### Definitions

As used herein, the terms “battery” and “capacitor” are to be given their ordinary and customary meanings to a person of ordinary skill in the art. The terms “battery” and “capacitor” are nonexclusive of each other. A capacitor or battery can refer to a single electrochemical cell that may be operated alone, or operated as a component of a multi-cell system.

As used herein, the voltage of an energy storage device is the operating voltage for a single battery or capacitor cell. Voltage may exceed the rated voltage or be below the rated voltage under load, or according to manufacturing tolerances.

As provided herein, a “self-supporting” electrode film is an electrode film that incorporates binder matrix structures sufficient to support the film or layer and maintain its shape such that the electrode film or layer can be free-standing. When incorporated in an energy storage device, a self-supporting electrode film or active layer is one that incorporates such binder matrix structures. Generally, and depending on the methods employed, such electrode films or active layers are strong enough to be employed in energy storage device fabrication processes without any outside supporting elements, such as a current collector or other film. For example, a “self-supporting” electrode film can have sufficient strength to be rolled, handled, and unrolled within an electrode fabrication process without other supporting elements. A dry electrode film, such as a cathode electrode film or an anode electrode film, may be self-supporting.

As provided herein, a “solvent-free” electrode film is an electrode film that contains no detectable processing solvents, processing solvent residues, or processing solvent impurities. A dry electrode film, such as a cathode electrode film or an anode electrode film, may be solvent-free.

A “wet” electrode, “wet process” electrode, or slurry electrode, is an electrode prepared by at least one step involving a slurry of active material(s), binder(s), and optionally additive(s). A wet electrode may include processing solvents, processing solvent residues, and/or processing solvent impurities.

### EXAMPLES

### Example 1: Thick Electrodes

Dry battery anodes were fabricated, which included 96% by weight graphite and 4% by weight binder, wherein the binder included 2% PTFE, 1% CMC and 1% PVDF by weight totaling the 4% of binder by weight. Cathodes were also fabricated in a dry process, the cathodes including 94% by weight NMC622, 3% by weight conductive additive, and 3% by weight polymer binder. In addition, wet process electrodes were fabricated having the following compositions: the wet process anode included 95.7% by weight graphite, 1% conductive additive, and 3.3% by weight polymer binders, and the wet process cathode included 91.5% by weight active component and 4.4% by weight conductive additive and 4.1% by weight polymer binder. Other electrode film compositions can be envisioned and prepared, and the disclosure herein is not limited to the specific compositions disclosed.

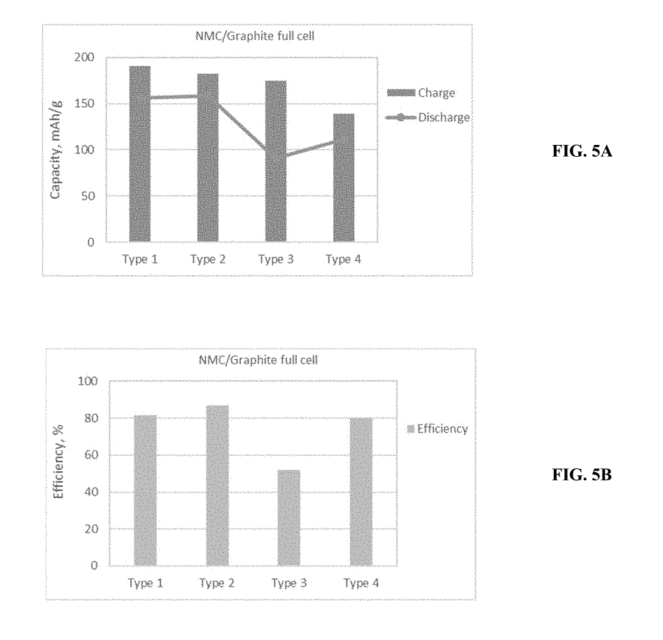

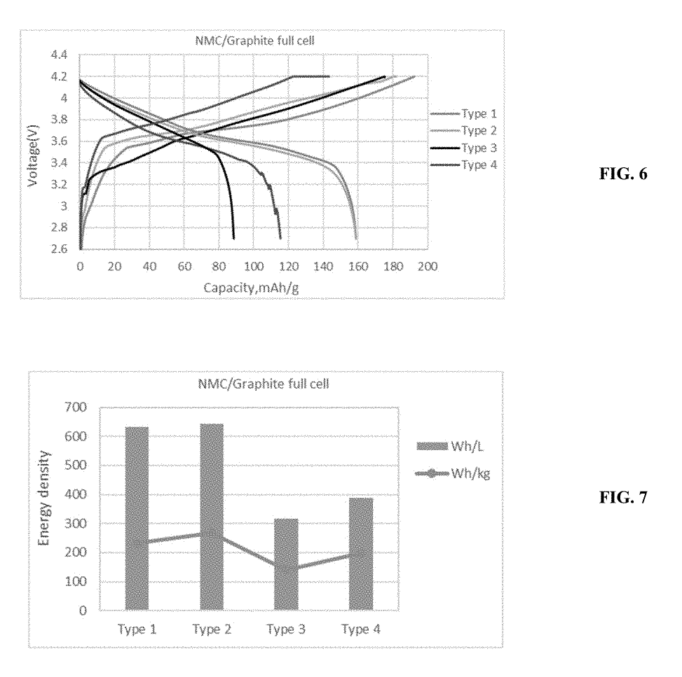

Four lithium ion batteries were assembled, following the scheme of Table 1. Each lithium ion battery of Table 1 was tested for specific capacity (see FIG. 5A), coulombic efficiency (see FIG. 5B), polarization on charge and discharge (see FIG. 6), and energy density/specific energy density (see FIG. 7).

As can be seen in FIGS. 5A and 5B, the performance of a battery incorporating a dry electrode was better than one a including a wet cathode and a wet anode. In FIG. 5A, the batteries including a dry cathode (“Type 1” and “Type 2”) had the best measured specific capacity. In FIG. 5B, the batteries including a dry cathode (again “Type 1” and “Type 2”) had the best measured coulombic efficiency. For the batteries tested in FIGS. 5A and 5B, the electrode material loading was: Type 1: 20.9 mg/cm²; Type 2: 24.3 mg/cm²; Type 3: 22.8 mg/cm²; and Type 4: 24.1 mg/cm².

FIG. 6 depicts the polarization behavior of full lithium ion battery cells of electrode pairs assembled according to Table 1. A lithium ion battery including a paired wet anode and wet cathode (“wet-wet,” Type 4 of Table 1) exhibited steep voltage polarization on charge and rapid voltage depression on discharge, when compared to a paired dry anode and dry cathode (“dry-dry,” Type 1 of Table 1). This is supportive of a higher ohmic resistance across the wet-wet paired cell. Without being limited by theory, it is thought that slower diffusion of lithium ion under a similarly applied current caused the wet-wet cell to exhibit increased resistance. In the example depicted, the voltage profile is noticeably improved when the wet cathode is replaced with a dry cathode (“dry-wet,” corresponding to Type 2 of Table 1), indicating that the incorporation of a dry electrode alleviated the observed ohmic impedance in the wet-wet cell. For the batteries tested in FIG. 6, the electrode material loading was: Type 1: 20.9 mg/cm²; Type 2: 23.9 mg/cm²; Type 3: 23.0 mg/cm²; and Type 4: 23.8 mg/cm².

As seen in FIG. 7, a lithium ion battery incorporating a self-supporting dry cathode demonstrated significantly improved energy density and specific energy density, as compared to wet-wet battery cells. In the embodiment of FIG. 7, the energy density and specific energy of cells incorporating a dry cathode (“Type 1” and “Type 2”) were markedly higher than those with a wet cathode (“Type 3” and “Type 4”).

As shown, dry battery electrodes can in some implementations elevate the electrochemical performance of an energy storage device. For example, a dry battery electrode was found to improve the performance of an energy storage device incorporating a wet process electrode, compared to an energy storage device incorporating only wet process electrodes. In particular, use of a self-supporting dry cathode was found to improve the performance of a lithium ion battery.

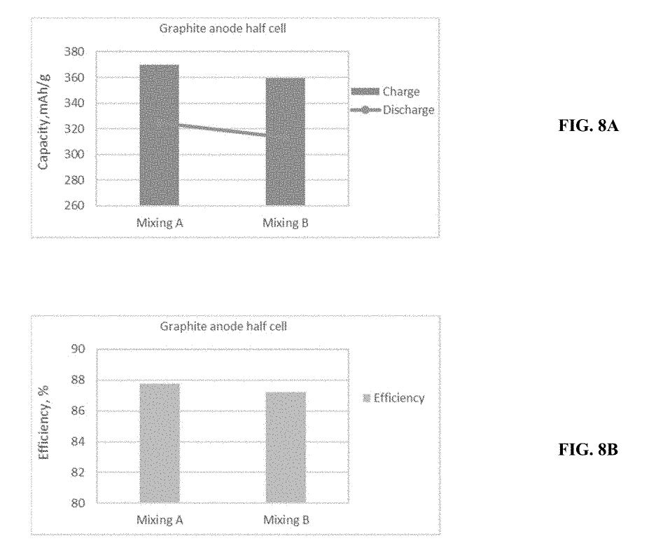

FIGS. 8A and 8B, respectively, provide specific capacity and coulombic efficiency results for graphite anodes prepared by two different dry mixing processes using identical anode formulations. An anode film comprising graphite, binder and additives was mixed in multiple sequential steps (“Mixing A”), and a second anode film was fabricated in which all materials were mixed in one step (“Mixing B”). Mixing A was conducted in following sequence: graphite and a first binder (CMC) were combined to form a first mixture, the first mixture was combined with a second binder (PVDF) to form a second mixture, and the second mixture was combined with a third binder (PTFE) to form a third mixture. The mixing conditions at each step were identical. The anode corresponding to Mixing A yielded a higher specific charge/discharge capacity. Both Mixing A and Mixing B anodes yielded similar coulombic efficiency. Without being limited by theory, coulombic efficiency is thought to be determined in part by the amount of surface area of the active materials. Thus, the enhanced electrochemical performance in Mixing A can be hypothesized to result from uniform distribution of the powder components in the Mixing A electrode. The electrode material loading was Mixing A electrode: 23.1 mg/cm²; Mixing B electrode: 23.4 mg/cm².

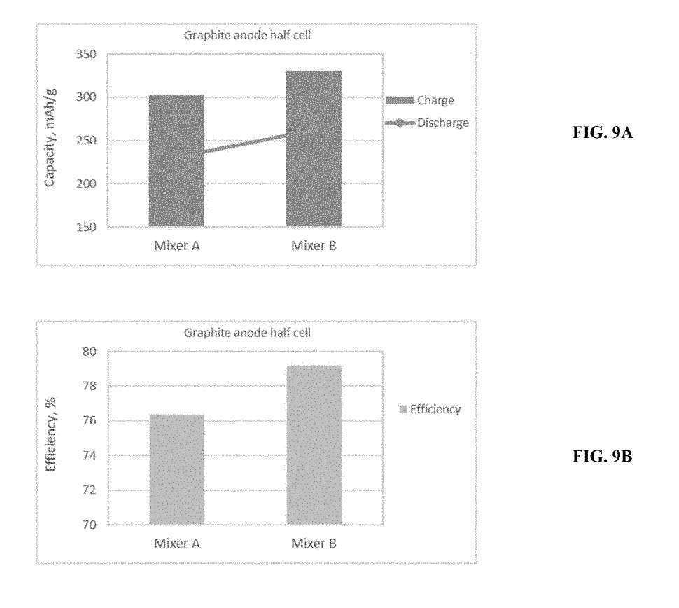

FIGS. 9A and 9B, respectively, provides specific capacity and coulombic efficiency results for graphite anodes prepared using two different mixer technologies used to process identical anode formulations. An anode comprising graphite, binder and additives was combined in a blade blender (“Mixer A”), and a second anode was fabricated in which the materials were combined in an acoustic resonant mixer (“Mixer B”). The anode electrochemical performance produced by the Mixer B anode was higher in both specific charge/discharge capacity and coulombic efficiency. It can be hypothesized that the powder components are better dispersed in the Mixer B electrode, while the active material particles are less adversely damaged. The electrode material loading was: Mixer A electrode: 16 mg/cm²; Mixer B electrode: 17.8 mg/cm².

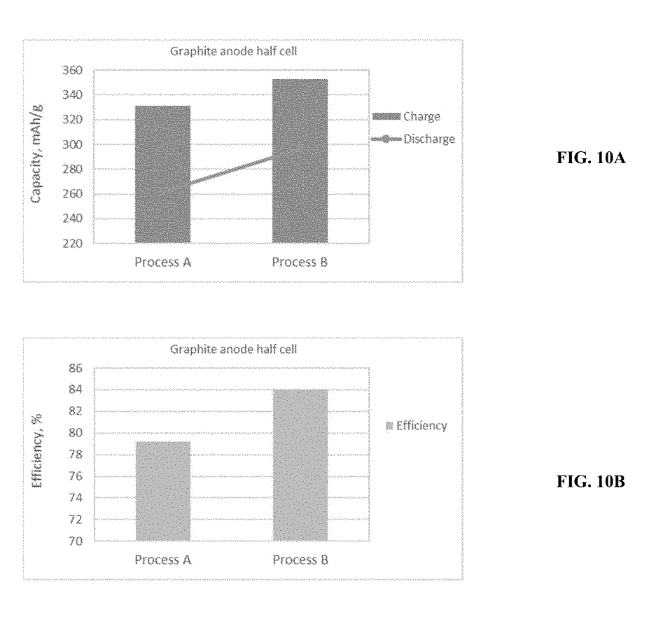

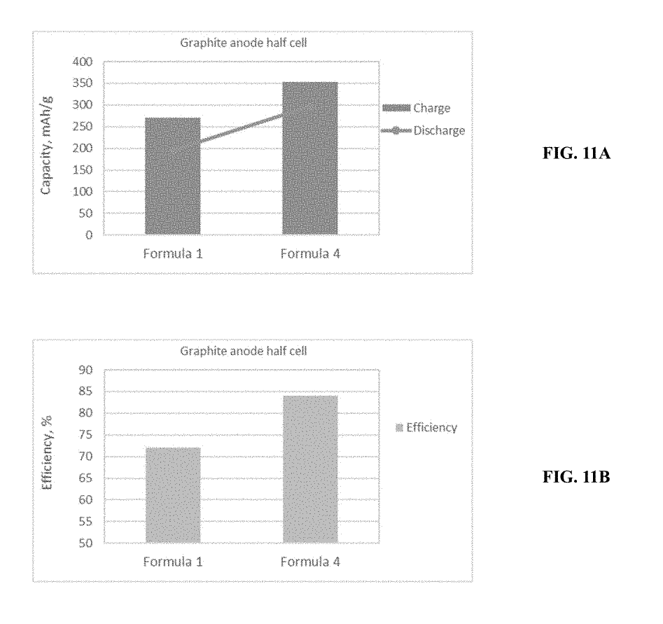

FIGS. 10A and 10B, respectively, provide specific capacity and coulombic efficiency results for graphite anodes of identical material compositions prepared using non-pre-milled polymer binder (comparative “Process A”) and pre-milled polymer binder processed through a jet mill prior to the introduction of the remaining electrode formulation components, followed by the execution of subsequent processing steps (“Process B”). The Process B electrode was superior in both specific charge/discharge capacity and in coulombic efficiency to Process A. The electrode material loading was: Process A electrode: 17.8 mg/cm², Process B electrode: 19.5 mg/cm².

Two additional anodes were fabricated and tested. A first dry battery graphite anode was prepared using active material that was processed using a jet-milling step, and binder that was also processed using a jet-milling step (“Formula 1”). A second dry battery graphite anode was prepared using active material that was processed using a gentle powder process such as a tumble blender, and was not subject to a jet-milling step, and binder that was processed using a jet-milling step (“Formula 4”). Specific capacity and coulombic efficiency results appear in FIGS. 11A and 11B. The Formula 4 electrode, having nondestructively processed active material and jet-milled binder, provided better specific capacity and efficiency performance than the Formula 1 electrode. The electrode material loading was: Formula 1 electrode: 20.2 mg/cm²; Formula 4 electrode: 19.5 mg/cm².

### Example 2: Thick Dry Electrode Specific Capacity

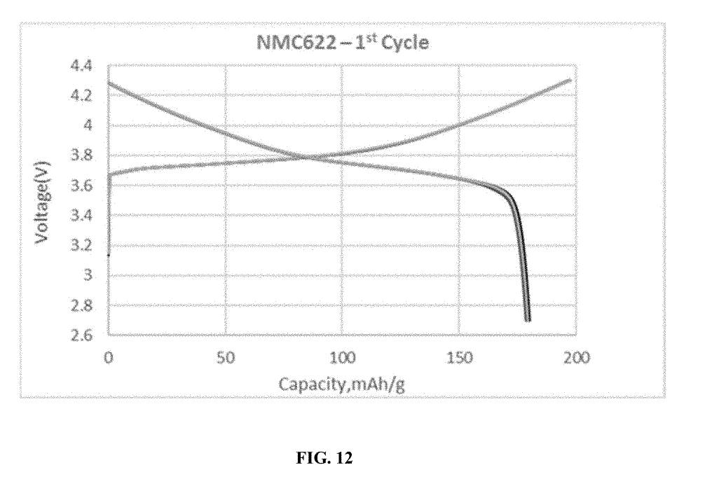

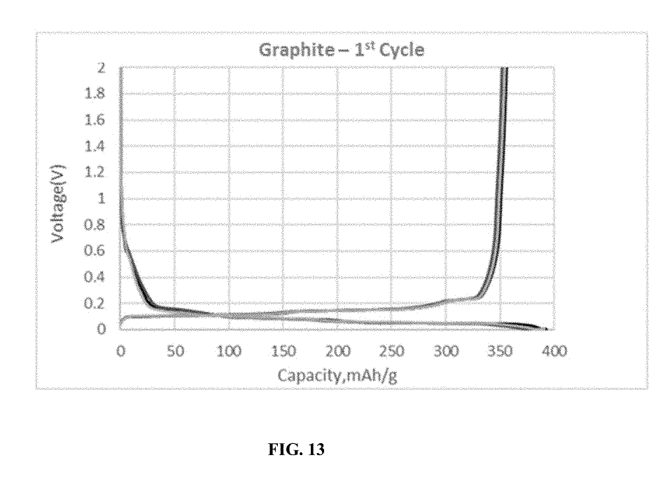

Table 3 provides the electrode specifications for thick NMC622 cathode and thick graphite anode. The NMC622 cathode is composed of 94 wt % NMC622, 2 wt % porous carbon, 1 wt % conductive carbon and 3 wt % PTFE. The graphite anode is composed of 96 wt % graphite, 1.5 wt % CMC, 0.5 wt % PVDF and 2 wt % PTFE. The half-cell 1^{st} cycle results are captured in FIGS. 12 and 13 for dry NMC622 and graphite electrode, respectively. The half-cell in FIG. 12 was charged at room temperature at a constant current of C/20 to a 4.3V cutoff, then a constant voltage to a C/40 cutoff, and then discharged at room temperature at a constant current of C/20 to a 2.7V cutoff. The half-cell in FIG. 13 was charged at room temperature at a constant current of C/20 to a 5 mV cutoff, then a constant voltage to a C/40 cutoff, and the discharged at room temperature at a constant current of C/20 to a 2V cutoff. The first cycle specific discharge capacity for both polarities exceeds the manufacturer's specified target capacity of 175 mAh/g for NMC622 and 350 mAh/g as recorded in Table 4. These half-cell electrochemical results indicate that thick dry coated lithium-ion battery electrodes show improved functionality.

TABLE 3

| | | |
|---|---|---|
| Electrode Spec | NMC622 Cathode | Graphite Anode |

| | | | | |
|---|---|---|---|---|
| Active | 95 | wt. % | 96 | wt. % |
| Electrode | 39.5 | mg/cm² | 20.7 | mg/cm² |
| Material Loading | | | | |
| Weight | | | | |
| Electrode Film | 3.38 | g/cm³ | 1.53 | g/cm³ |
| Density | | | | |
| Areal Capacity | 6.6 | mAh/cm² | 7.0 | mAh/cm² |
| Thickness | 117 | μm | 135 | μm |

TABLE 4

| | 1^{st} Specific | 1^{st} Specific | |
|---|---|---|---|
| Electrode | Charge Capacity | Discharge Capacity | Efficiency |
| 95% NMC622 | 197 mAh/g | 179 mAh/g | 90.9% |
| 96% Graphite | 391 mAh/g | 354 mAh/g | 90.6% |

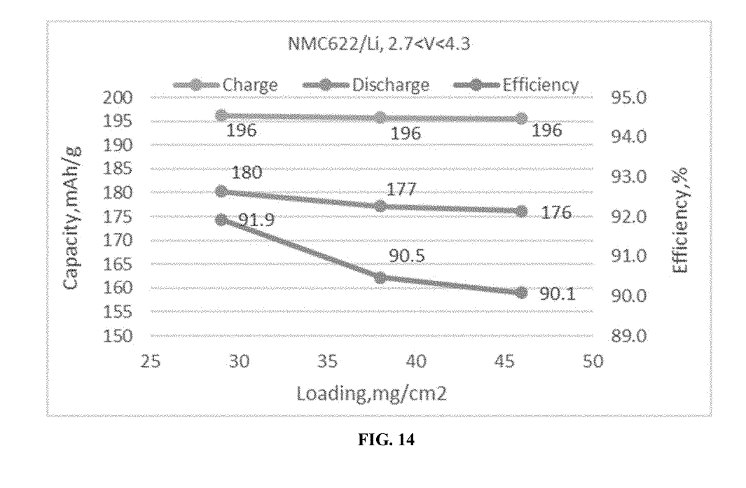

FIG. 14 provides first cycle electrochemical half-cell results for dry coated NMC622 electrode at electrode material loading weights of about 29 mg/cm², about 38 mg/cm² and about 46 mg/cm². The corresponding electrode thicknesses are proportional to these three loadings, 117 μm, 137 μm and 169 μm, respectively. The specific charge capacity is 196 mAh/g for all three cathodes. The specific discharge capacity for all three cathodes are above the manufacturer's 175 mAh/g target for NMC622; as such, their efficiency is above 90% (discharge capacity divided by charge capacity). For comparison, wet coated NMC622 cathodes at about 80 um thick offer about 87.5% efficiency and similar specific charge capacity. At higher thicknesses, wet coated electrodes typically regress in energy density, fast charge capability, cycle life and high temperature storage (supporting data provided below). These results demonstrate that dry coated thick NMC622 cathode can offer faster charging and higher energy density than traditional wet coated electrodes.

### Example 3: Thick Electrode Charge and Discharge Performance

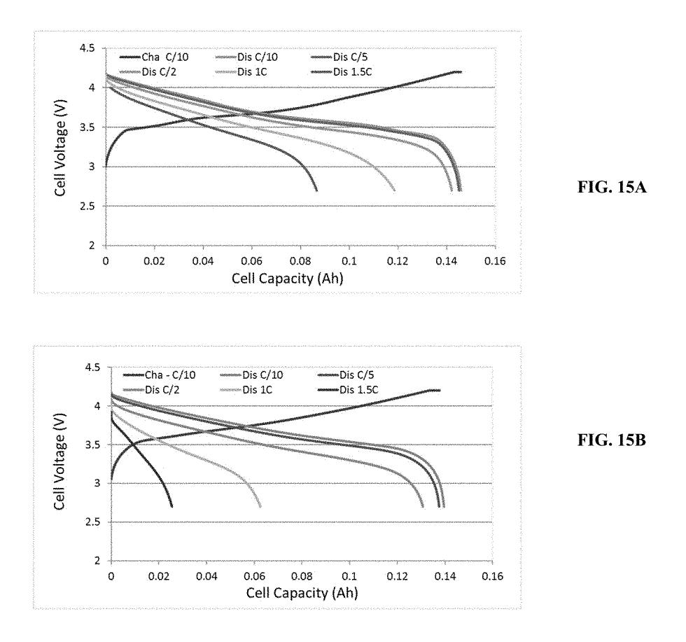

FIGS. 15A and 15B provide the discharge rate voltage profiles for dry and wet coated electrodes, respectively. The active material used in both coating technologies are NMC622 for the cathode and graphite for the anode. The wet NMC622 cathode is composed of about 92 wt % NMC622, 4 wt % conductive carbon and 4 wt % PVDF. The wet NMC622 cathode was formed with a 41.0 mg/cm² loading, which gave a 155 μm thick film, a 36% porosity, and a 2.66 g/cm³ electrode film density. The wet graphite anode is composed of about 96 wt % graphite, 1 wt % conductive carbon and 3 wt % CMC/styrene-butadiene binder. The wet graphite anode was formed with a 24.5 mg/cm² loading, which gave a 182 μm thick film, a 37.5% porosity, and a 1.35 g/cm³ electrode film density.

The dry NMC622 cathode is composed of about 95 wt % NMC622, 2 wt % porous carbon, 1 wt % conductive carbon and 2 wt % PTFE. The dry graphite anode is composed of about 96 wt % graphite, 1 wt % CMC, 1 wt % PVDF, 2 wt % PTFE. Further characteristics of the dry NMC622 cathode and dry graphite anode are shown below in Table 5.

TABLE 5

| Dry Electrode Spec | NMC622 Cathode | | Graphite Anode | |
|---|---|---|---|---|
| Active | 95 | wt. % | 96 | wt. % |
| Electrode Material Loading Weight | 35.5 | mg/cm² | 19.5 | mg/cm² |
| Electrode Film Density | 3.05 | g/cm³ | 1.42 | g/cm³ |
| Areal Capacity | 5.9 | mAh/cm² | 6.6 | mAh/cm² |
| Thickness | 117 | μm | 137 | μm |

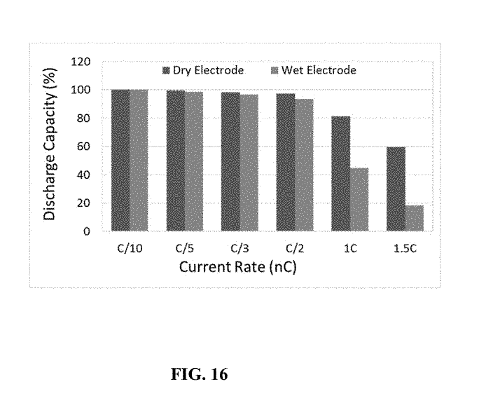

The designed electrode areal capacity is about 6.6 mAh/cm² and the cell format used to compare both coating technologies are identical. The charge rate used to establish cell capacity was measured at a C/10 rate, resulting in about 0.14 Ah for both dry and wet coated electrodes. As seen in FIG. 16, the charge capacity retention percentage, defined by the discharge capacity at a given rate divided by the discharge capacity measured at C/10, deteriorated much more rapidly for the wet coated electrodes as the discharge rate is increased from C/10 to 1.5C. These results demonstrate that for a given battery operating at 1.5C discharge rate, the dry coated electrodes will offer more than triple the runtime.

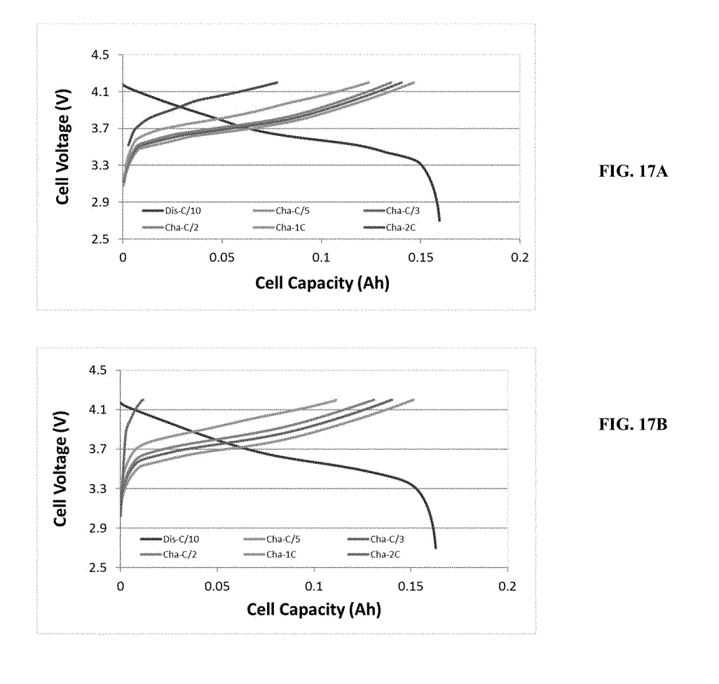

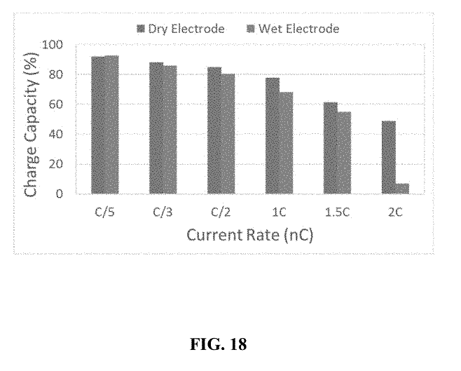

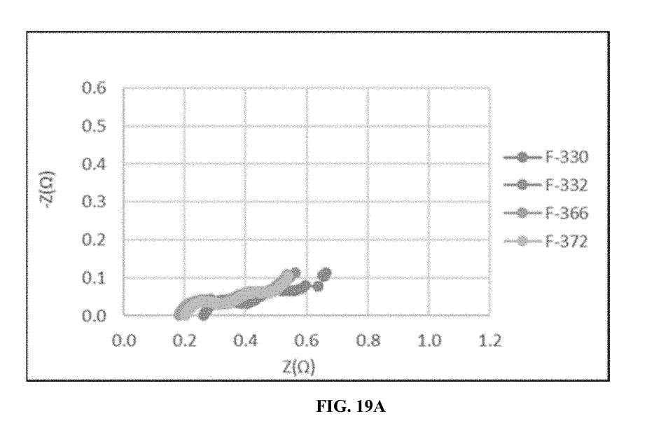

FIGS. 17A and 17B provide the charge rate voltage profiles for dry and wet coated electrodes, respectively. Both electrodes shown in FIGS. 17A and 17B were charged at constant currents. The active material used in both coating technologies are NMC622 for the cathode and graphite for the anode. The designed electrode areal capacity is 6.6 mAh/cm² and the cell format used to compare both coating technologies are identical. The discharge rate used to establish cell capacity was measured at a C/10 rate, resulting in about 0.16 Ah for both dry and wet coated electrodes. As seen in FIG. 18, the charge capacity production percentage, defined by the charge capacity measured at a given constant current rate divided by the discharge capacity measured at C/10, diminishes much more quickly for the wet coated electrodes as the charge rate is increased from C/5 to 2C compared to dry coated thick electrodes. These results demonstrate that for a given battery under fast charging conditions, such as the 2C rate, dry coated thick electrodes will offer more than five times the capacity of wet coated electrodes.

### Example 4: Thick Electrode High Temperature Storage

Table 6 provides the electrode specifications for thick NMC622 cathode and thick graphite anode produced by a dry process. The dry NMC622 cathode is composed of about 95 wt % NMC622, 2 wt % porous carbon, 1 wt % conductive carbon, and 2 wt % PTFE. The dry graphite anode is composed of about 96 wt % graphite, 1 wt % CMC, 1 wt % PVDF, and 2 wt % PTFE.

TABLE 6

| Dry Electrode Spec | NMC622 Cathode | | Graphite Anode | |
|---|---|---|---|---|
| Active | 94 | wt % | 95.5 | wt % |
| Electrode Material Loading Weight | 39.8 | mg/cm² | 21.7 | mg/cm² |
| Electrode Film Density | 3.25 | g/cm³ | 1.67 | g/cm³ |
| Areal Capacity | 6.5 | mAh/cm² | 7.2 | mAh/cm² |
| Thickness | 122 | μm | 130 | μm |

Table 7 provides the electrode specifications for thick NMC622 cathode and thick graphite anode produced by a wet process. The wet NMC622 cathode is composed of about 92 wt % NMC622, 4 wt % conductive carbon, and 4 wt % PVDF. The wet graphite anode is composed of about 96 wt % graphite, 1 wt % conductive carbon, and 3 wt % CMC/styrene-butadiene binder. The cell format used to compare coating technologies of Tables 5 and 6 are identical.

TABLE 7

| Wet Electrode Spec | NMC622 Cathode | | Graphite Anode | |
|---|---|---|---|---|
| Active | 92 | wt % | 96 | wt % |
| Electrode Material Loading Weight | 41.7 | mg/cm² | 23.6 | mg/cm² |
| Electrode Film Density | 2.66 | g/cm³ | 1.35 | g/cm³ |
| Areal Capacity | 6.7 | mAh/cm² | 7.9 | mAh/cm² |
| Thickness | 160 | μm | 166 | μm |

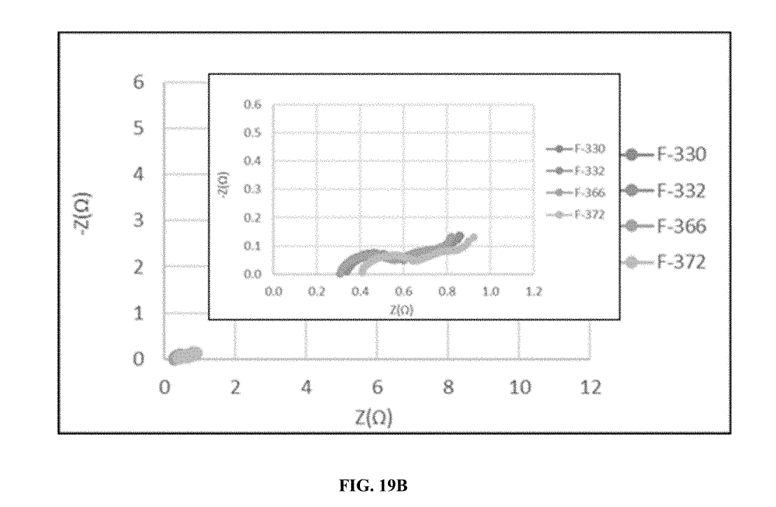

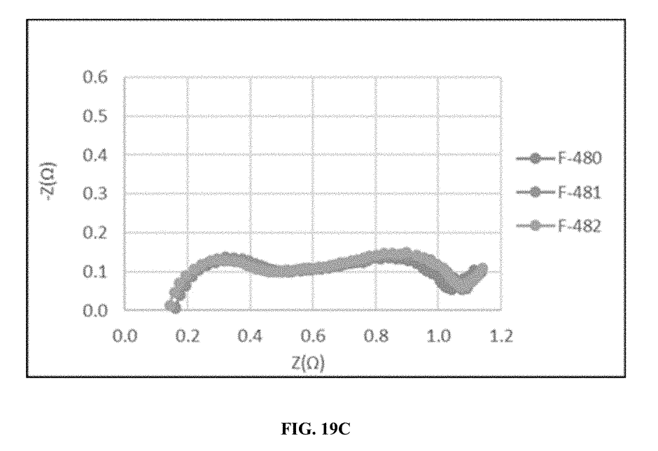

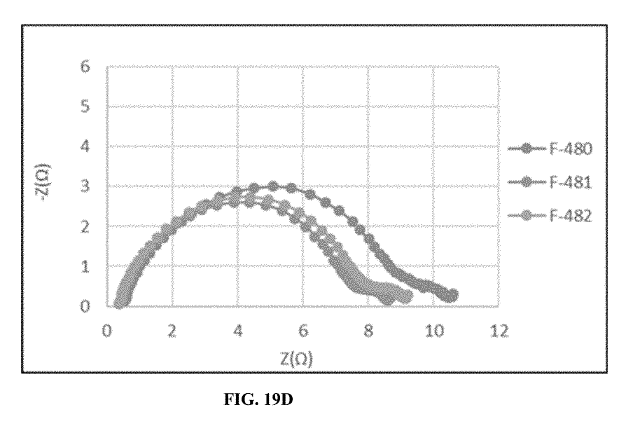

FIGS. 19A and 19B provide electrochemical impedance spectroscopy data for dry coated thick electrodes shown in Table 6 before and after aging, respectively. FIGS. 19C and 19D provide electrochemical impedance spectroscopy data for wet coated thick electrodes shown in Table 7 before and after aging, respectively. The measurements were recorded at 100% state-of-charge (SOC) for both before and after aging. The active material used in both coating technologies are NMC622 for the cathode and graphite for the anode. The resistance for dry coated electrode cells before high temperature storage is consistently lower than wet coated electrode cells, as seen when comparing FIGS. 19A and 19C. After storing the cells at 65 degrees Celsius at 100% SOC for 6 weeks, the wet coated electrode cell resistance increased about 10 folds compared to minimal change observed for the dry coated electrode cells, as seen when comparing FIGS. 19B and 19D.

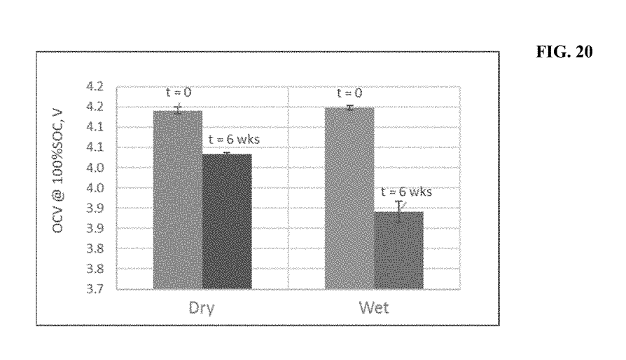

The cell voltage of the wet coated electrode is also impacted more severely than dry coated electrodes after 6 weeks of storage at 65 degrees Celsius and 100% SOC, as seen in FIG. 20. The voltage dropped for wet coated electrodes is about 3 times higher than dry coated electrodes, 255 millivolts compared to about 108 millivolts, respectively.

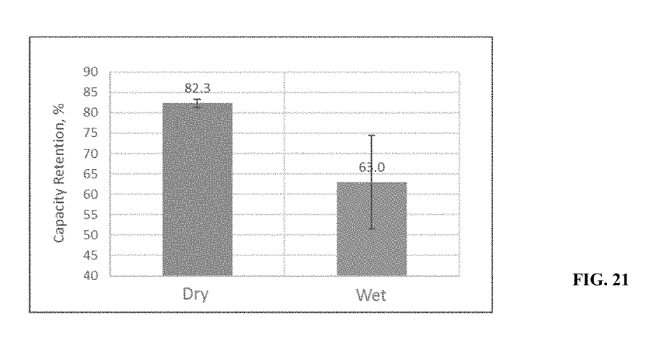

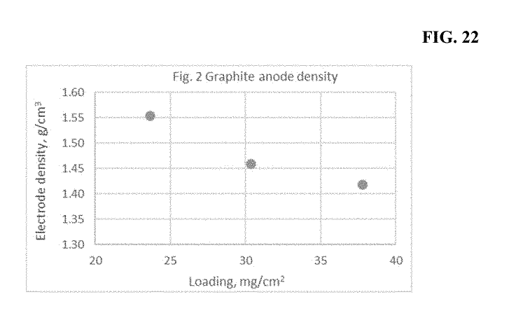

The high temperature storage conditions also significantly deteriorated the capacity of wet coated electrode cells compared to dry coated electrode cells after 6 weeks of aging, as seen in FIG. 21. The wet coated electrode cells lost about twice as much capacity as the dry coated electrode cells (37% vs. 17.7%) after 6 weeks at 100% SOC under 65 degrees Celsius.

The collection of comparative tests shown in FIGS. 19A-21 demonstrated that for a great number of applications, for example such as batteries for electric vehicles, dry coated thick electrodes provide longer range under high performance driving conditions, faster charging time and extended longevity relative to wet coated thick electrodes.

### Example 5: Dense Electrodes and Electrode Films

Electrode formulations and film calendering processes have been developed that improve electrode film density while maintaining physical properties and electrochemical performance of the electrode, and overcome the issues of wet casting high electrode material loadings previously described. Two electrode formulations comprising 94 wt % graphite active material and 6 wt % polymer binder that are calendered at temperatures ranging from 37° C. to about 150° C. Formula 1 is composed of 94 wt % graphite, 3 wt % CMC, and 3 wt % PTFE, and Formula 2 is composed of 94 wt % graphite, 2 wt % CMC, 1 wt % PVDF, and 3 wt % PTFE. It is demonstrated that significantly higher electrode film densities can be achieved by optimizing the formulation and calendering graphite electrodes at lower temperatures. The electrode film densities for Formulations 1 and 2 calendered at a number of temperatures are shown in Table 8 below.

TABLE 8

| | Temperature | Electrode Film Density |
|---|---|---|
| | (° C.) | (g/cm³) |
| Formula 1 | 37 | 1.75 |
| | 65 | 1.61 |
| | 93 | 1.65 |
| | 121 | 1.59 |
| | 148 | 1.51 |
| Formula 2 | 37 | 1.77 |
| | 65 | 1.65 |
| | 93 | 1.59 |
| | 121 | 1.51 |
| | 148 | 1.50 |

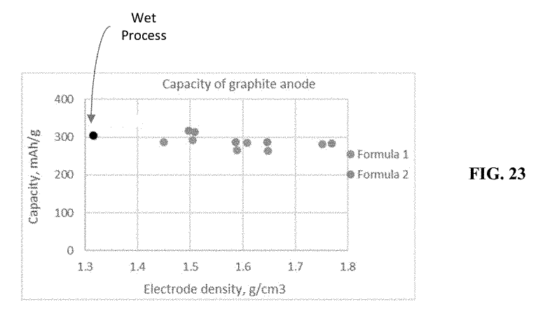

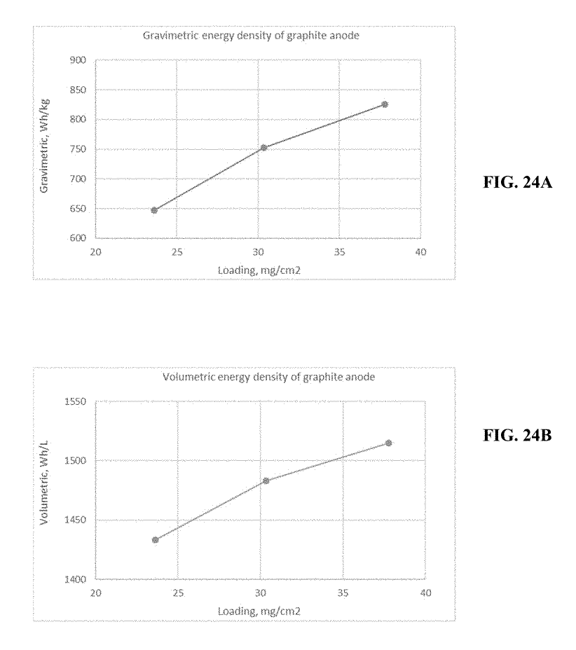

Furthermore, FIG. 23 demonstrates that extremely high electrode material loadings of around 40 mg/cm² and 50 mg/cm² for graphite anode and cathode, respectively, in the formulation of 94% active material, 6% binder can be fabricated through dry electrode process at temperature as low as 35° C. and demonstrated comparable reversible capacity delivery to conventional low film density wet electrode (referred to Benchmark) over wide range of electrode film density. In addition, FIGS. 24A and 24B demonstrate that energy densities of electrodes prepared with such high electrode material loadings and high electrode film densities show a 52% improvement in gravimetric density and a 198% improvement in volumetric density, respectively, in electrode level when compared to wet coated graphite anode at an electrode material loading of 24.7 mg/cm². In addition, electrode density increased by 36% compared to traditional wet slurry electrode.

### Solid State

In some instances, a solid state energy storage device comprising an electrode film described herein is disclosed. In some embodiments, the solid state energy storage device is a solid state battery. Solid state batteries provide improved safety by employing non-flammable components. Additionally, solid state batteries are able to safely utilize elemental lithium metal because dendrite formation is not as severe relative to typical liquid-based lithium ion batteries. Lithium metal offers a significantly higher theoretical specific capacity compared to graphite, and therefore it can improve energy density over typical lithium ion batteries. Furthermore, a dry electrode processing method is expected to be less expensive and safer than conventional methods. Typically, a solid state lithium battery comprises an ionic and/or electronic conducting cathode, a solid electrolyte and a lithium metal anode. In some embodiments, at least one of the solid electrodes comprises a solid electrolyte salt. In some embodiments, the solid electrolyte is an ion conducting inorganic solid electrolyte. In some embodiments, the solid electrolyte is a polymer-based film. In some embodiments, a dry processed composite solid polymer electrolyte (SPE).

In some embodiments, the solid electrolyte salt is a lithium salt. In some embodiments, the lithium salt is selected from at least one of lithium hexafluorophosphate, lithium bis(trifluoromethanesulfonyl)imide, lithium tetrafluoroborate, lithium trifluoromethanesulfonate, lithium bis(fluorosulfonyl)imide, lithium bis(pentafluoroethanesulfonyl)imide, lithium bis(oxalato)borate, and lithium perchlorate. In some embodiments, the electrode salt has a garnet structure, for example, Li_{6.5}La₃Zr_{1.5}Ta_{0.5}O₁₂, Li₆La₃SnMO₁₂ (M=Sb, Nb, Ta, Zr), Li₅La₃Ta₂O₁₂ and Li₃N. In some embodiments, the electrode salt is a sulfur based electrode salt, for example Li₂S—P₂S₅ and Li₂S—P₂S₅—Li₃PO₄. In some embodiments, the electrode salt is Li_{0.5}La_{0.5}TiO₃ (LLTO) and/or Li₇La₃Zr₂O₁₂ (LLZO). In some embodiments, the electrode salt is a LISCON (Lithium Super Ionic Conductor), for example the LISCON may have a molecular formula of Li₍₂₊₂ₓ₎Zn₍₁₋ₓ₎GeO₄.

In some embodiments, the composite solid polymer electrolyte (SPE) comprises at least one ion conducting polymer. In some embodiments, the SPE comprises at least one lithium ion salt. In some embodiments, the SPE comprises at least one supporting polymer binder. In some embodiments, the SPE comprises at least one filler. In some embodiments, the SPE comprises at least one ion conducting polymer and at least one lithium ion salt. In some embodiments, the SPE comprises at least one ion conducting polymer, at least one one lithium ion salt and at least one supporting polymer. In some embodiments, the SPE comprises at least one ion conducting polymer, at least one lithium ion salt, at least one supporting polymer and at least one filler.

In some embodiments, the ion conducting polymer is selected from at least one of polyethylene oxide (PEO), polyvinylidene fluoride (PVDF), poly(vinylidene fluoride-co-hexafluoropropylene) (PVDF-HFP), poly(methylene oxide), polyoxymethylene, poly(vinyl alcohol) (PVA), poly(vinyl pyrrolidone) (PVP), poly(methyl methacrylate), poly(vinyl acetate), poly(vinylchloride), poly(vinyl acetate), poly(oxyethylene)₉methacrylate, poly(ethylene oxide) methyl ether methacrylate, and poly(propylenimine).

In some embodiments, the lithium salt is selected from at least one of lithium hexafluorophosphate, lithium tetrafluoroborate, lithium bis(fluorosulfonyl)imide, lithium bis(pentafluoroethanesulfonyl)imide, lithium perchlorate (LiClO₄), lithium bis(trifluoromethane sulfonimide) (LiTFSI) (Li(C₂F₅SO₂)₂N), lithium bis(oxalato)borate (LiB(C₂O₄)₂), lithium trifluoromethanesulfonate (LiCF₃SO₃), Li_{6.4}La₃Zr_{1.4}Ta_{0.6}O₁₂, Li₇La₃Zr₂O₁₂, Li₁₀SnP₂S₁₂, Li₃xLa_{2/3-x}TiO₃, Li_{0.8}La_{0.6}Zr₂(PO₄)₃, Li₁₊ₓTi₂₋ₓAlₓ(PO₄)₃, Li_{1+x+y}Ti₂₋ₓAlₓSi_{y}(PO₄)_{3-y}, and LiTiₓZr₂₋ₓ(PO₄)₃. In some embodiments, the lithium salt may be a lithium salt previously described herein.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The headings provided herein, if any, are for convenience only and do not necessarily affect the scope or meaning of the devices and methods disclosed herein.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A single dry electrode film of an energy storage device, comprising:
a dry active material; and
a dry binder;
wherein the dry electrode film is free-standing, and
wherein the dry electrode film is greater than about 110 μm in thickness.

2. The dry electrode film of claim 1, wherein the electrode film porosity of the dry electrode film is at most about 20%.

3. The dry electrode film of claim 1, wherein the electrode film is at least 0.8 g/cm³ in electrode film density.

4. The dry electrode film of claim 1, wherein the electrode material loading of the electrode film is at least about 20 mg/cm².

5. The dry electrode film of claim 1, wherein the dry electrode film comprises at least about 90 wt % of the dry active material.

6. The dry electrode film of claim 1, wherein the dry active material comprises an anode active material.

7. The dry electrode film of claim 6, wherein the anode active material comprises a carbon active material.

8. The dry electrode film of claim 7, wherein the carbon active material comprises graphite.

9. The dry electrode film of claim 1, wherein the dry active material comprises a cathode active material.

10. The dry electrode film of claim 9, wherein the cathode active material comprises a lithium nickel manganese cobalt oxide (NMC).

11. The dry electrode film of claim 9, wherein the cathode active material comprises a sulfur-based material.

12. The dry electrode film of claim 1, wherein the dry binder comprises a fibrillizable binder.

13. The dry electrode film of claim 1, wherein the dry binder comprises at least one of polytetrafluoroethylene (PTFE), carboxymethylcellulose (CMC), and polyvinylidene fluoride (PVDF).

14. The dry electrode film of claim 13, wherein the dry binder comprises polytetrafluoroethylene (PTFE), carboxymethylcellulose (CMC), and polyvinylidene fluoride (PVDF) in a ratio of 2:1:1 by weight.

15. The dry electrode film of claim 1, wherein the dry electrode film comprises up to about 20 wt % of the dry binder.

16. The dry electrode film of claim 1, further comprising a conductive additive.

17. The dry electrode film of claim 16, wherein the dry electrode film comprises up to about 5 wt % of the conductive additive.

18. The dry electrode film of claim 1, further comprising a porous material.

19. The dry electrode film of claim 18, wherein the dry electrode film comprises up to about 10 wt % of the porous material.

20. An electrode comprising the dry electrode film of claim 1 in contact with a current collector.

21. The electrode of claim 20, wherein the volumetric energy density of the electrode is at least about 550 Wh/L.

22. The electrode of claim 20, wherein the specific energy density of the electrode is at least about 200 Wh/kg.

23. The electrode of claim 20, wherein the specific capacity of the electrode is at least about 150 mAh/g.

24. The electrode of claim 20, wherein the areal capacity of the electrode is at least about 3.5 mAh/cm².

25. The electrode of claim 24, wherein the areal capacity is discharging capacity.

26. The electrode of claim 20, wherein the charge capacity retention percentage at a discharge rate of 1.5C is at least about 20%.

27. The electrode of claim 20, wherein the charge capacity production percentage at a charge rate of 2C is at least about 10%.

28. The electrode of claim 20, wherein the Coulombic efficiency is at least about 85%.

29. A lithium ion battery comprising the electrode of claim 20.

30. A solid state lithium ion battery comprising the electrode of claim 20.

31. (canceled)

32. (canceled)

33. The dry electrode film of claim 3, wherein the dry electrode film is greater than about 155 μm in thickness.

34.-70. (canceled)
